(19) United States
(12) Patent Application Publication
(10) Pub. No.: US 2025/0375708 A1
(43) Pub. Date: Dec. 11, 2025

(54) EQUIPMENT PROVIDING METHOD AND APPARATUS FOR VIRTUAL PIECE, DEVICE, AND MEDIUM

(71) Applicant: Tencent Technology (Shenzhen) Company Limited, Shenzhen (CN)

(72) Inventor: Ziqi WEI, Shenzhen (CN)

(21) Appl. No.: 19/309,458

(22) Filed: Aug. 25, 2025

Related U.S. Application Data
(63) Continuation of application No. PCT/CN2024/084574, filed on Mar. 28, 2024.

(30) Foreign Application Priority Data
Jun. 15, 2023 (CN) 202310713768.2

(51) Int. Cl. A63F 13/56

(52) U.S. Cl. CPC A63F 13/56

(57) ABSTRACT

This application provides a method and apparatus for switching equipment between virtual pieces of an online board game. The method includes: displaying a battle board, the battle board including a first virtual piece and a second virtual piece controlled by a first account of the online board game; in response to a first selection operation on the first virtual piece, updating the first virtual piece to be in a selected state and displaying first equipment associated with the second virtual piece in an equipment bar on the battle board; and in response to a second selection operation on the first equipment in the equipment bar, dynamically moving the first equipment from the second virtual piece to the first virtual piece in the battle board. Through the method, fixed-point provision of equipment for a virtual piece may be implemented, thereby quickly and accurately providing the equipment to the virtual piece.

### CROSS-REFERENCE TO RELATED APPLICATIONS

This application is a continuation application of PCT Patent Application No. PCT/CN2024/084574, entitled “EQUIPMENT PROVIDING METHOD AND APPARATUS FOR VIRTUAL PIECE, DEVICE, AND MEDIUM” filed on Mar. 28, 2024, which claims priority to China Patent Application No. 202310713768.2, entitled “METHOD AND APPARATUS FOR PROVIDING VIRTUAL PIECE EQUIPMENT, DEVICE, AND MEDIUM” filed with the China National Intellectual Property Administration on Jun. 15, 2023, both of which are incorporated herein by reference in their entirety.

### FIELD OF THE TECHNOLOGY

Embodiments of this application relate to the field of human-computer interaction, and in particular, to an equipment providing method and apparatus for a virtual piece, a device, and a medium.

### BACKGROUND OF THE DISCLOSURE

A turn-based board game is a new type of board game. After two sides of a battle place virtual pieces in a combat area of a battle board, a game application automatically controls the virtual pieces of the two sides on the battle board to battle against each other and displays a result of the battle.

In the related art, the virtual pieces in the turn-based board game are usually provided with an equipment mechanism. In other words, the virtual pieces obtain stronger combat capability through adding equipment to the virtual pieces. For example, in a process of providing the equipment of a virtual piece A for a virtual piece B, a player needs to first disassemble the equipment from the virtual piece A, then select the disassembled equipment in an equipment bar, and finally drag the equipment to the virtual piece B. The process has complex operations, and an accidental touch easily occurs during dragging because a plurality of virtual pieces exist on the battle board, resulting in low equipment providing efficiency of the virtual pieces.

### SUMMARY

Embodiments of this application provide an equipment providing method and apparatus for a virtual piece, a device, and a medium. The technical solutions are as follows.

According to an aspect, a method for moving equipment between virtual pieces in an online board game is performed by a computer device, the method comprising:
displaying a battle board, the battle board including a first virtual piece and a second virtual piece controlled by a first account of the online board game;
in response to a first selection operation on the first virtual piece, updating the first virtual piece to be in a selected state and displaying first equipment associated with the second virtual piece in an equipment bar on the battle board; and
in response to a second selection operation on the first equipment in the equipment bar, dynamically moving the first equipment from the second virtual piece to the first virtual piece in the battle board.

According to another aspect, a computer device is provided, including a processor and a memory, the memory having at least one program stored therein, the at least one program, when being loaded and executed by the processor, causing the computer device to implement the equipment-switching method for virtual pieces described in the above aspect.

According to another aspect, a non-transitory computer-readable storage medium is provided, having at least one program stored therein, the at least one program being loaded and executed by a processor of a computer device, causing the computer device to implement the equipment-switching method for virtual pieces described in the above aspect.

The technical solutions provided in the embodiments of this application have at least the following beneficial effects.

In an equipment process of providing the virtual piece, equipment to be provided for the virtual pieces can be selected in the equipment bar only by selecting the virtual piece, thereby quickly providing the virtual piece, avoiding redundant operations of first disassembling and then dragging and providing the equipment, saving operation costs, and improving equipment providing efficiency of the virtual piece. In addition, when the virtual pieces on the battle board are dense, accidental touches easily caused by dragging the equipment to the virtual pieces may be effectively avoided, and the equipment of the virtual pieces may be accurately provided, thereby improving equipment providing accuracy of the virtual pieces.

### BRIEF DESCRIPTION OF THE DRAWINGS

FIG. 1 is a schematic diagram of a battle interface of a turn-based board game according to an exemplary embodiment of this application.

FIG. 2 is a structural block diagram of a computer system according to an exemplary embodiment of this application.

FIG. 3 is a schematic diagram of an interface for an equipment providing method for a virtual piece in the related art.

FIG. 4 is a schematic diagram of an interface for an equipment providing method for a virtual piece according to an exemplary embodiment of this application.

FIG. 5 is a schematic diagram of an interface for an equipment providing method for a virtual piece according to another exemplary embodiment of this application.

FIG. 6 is a flowchart of an equipment providing method for a virtual piece according to an exemplary embodiment of this application.

FIG. 7 is a schematic diagram of an interface for an equipment providing method for a virtual piece according to another exemplary embodiment of this application.

FIG. 8 is a schematic diagram of an interface for an equipment providing method for a virtual piece according to another exemplary embodiment of this application.

FIG. 9 is a flowchart of an equipment providing method for a virtual piece according to an exemplary embodiment of this application.

FIG. 10 is a schematic diagram of an interface for an equipment bar according to an exemplary embodiment of this application.

FIG. 11 is a schematic diagram of an interface for an equipment providing method for a virtual piece according to another exemplary embodiment of this application.

FIG. 12 is a schematic diagram of an interface for an equipment providing method for a virtual piece according to another exemplary embodiment of this application.

FIG. 13 is a flowchart of an equipment providing method for a virtual piece according to an exemplary embodiment of this application.

FIG. 14 is a block diagram of an equipment providing apparatus for a virtual piece according to an exemplary embodiment of this application.

FIG. 15 is a block diagram of a terminal according to an exemplary embodiment of this application.

### DESCRIPTION OF EMBODIMENTS

To make objectives, technical solutions, and advantages of this application clearer, implementations of this application are to be further described in detail below with reference to the accompanying drawings.

First, terms involved in the embodiments of this application are described.

Turn-based board game: It refers to a board game in which “pieces” (virtual pieces) are prearranged before a chess battle, and the “pieces” may automatically battle based on the prearrangement during the battle. The “pieces” are usually represented by virtual characters. During the battle, the virtual characters automatically release various skills to battle. Battles are usually turn-based. When all “pieces” of one side in the battle are killed (i.e., a hit point of the virtual character is reduced to zero), this side is a defeated side of the battle of the current turn. In some embodiments, in addition to having “piece virtual characters” for playing a game, two sides of a battle also have virtual characters (chess players) representing users participating in the battle. The virtual character cannot be moved to a combat area or a preparation area as a “piece”. The virtual character is also provided with a hit point (or a blood volume). The hit point of the virtual character is reduced (the battle fails) or stays unchanged (the battle succeeds) based on a result of each battle. When the hit point of the virtual character is reduced to zero, the user corresponding to the virtual character exits the battle, and the remaining user continues to battle. In some embodiments, the turn-based board game includes an auto chess.

Auto chess: It is a turn-based board game, and is an eight-player turn-based competitive game of an intra-episode hero card. Eight players exist in the game in total, and each of the players occupies a board. Each turn includes two stages: a preparation stage and a combat stage. In the preparation stage, a user purchases virtual pieces (heroes) in a store and makes a deployment on a board. In the battle stage, lineups of both sides are locked, and the virtual pieces automatically engage in a battle until all virtual pieces of one side are killed. A player whose pieces are all killed is the defeated side of the current turn, and a specific amount of blood volume is deducted from the player. Game turns are continuously repeated and new opponents are matched until the hit point of a player is ≤0 and the player is eliminated. A last remaining player finally wins the game (the 1^{st} place). Rankings (the 2^{nd} place to the 8^{th} place) of other players are determined based on blood volumes at the time of death.

Battle board: It refers to an area configured to prepare and perform a battle in a battle interface of a turn-based board game. The board may be any one of a two-dimensional (2D) virtual board, a 2.5-dimensional (2.5D) virtual board, and a three-dimensional (3D) virtual board, which is not limited in the embodiments of this application. The battle board is divided into a combat area or a preparation area.

Combat area: It is a place in which heroes of two sides (virtual pieces) combat with each other in auto chess. In a preparation stage, the heroes of the two sides are divided into an allied deployment area and an enemy deployment area. In the preparation stage, a player may place an obtained hero in the allied deployment area. In a combat stage, the deployment areas of the two sides merge to form a complete combat area, and the heroes of the two sides automatically combat in the combat area. A quantity of virtual pieces that may be placed in a combat area is limited. The quantity limitation is determined by elements such as a player level and a special prop.

The combat area includes several piece positions with the same size. The piece positions are configured for placing combat pieces to battle during the combat.

Preparation area: It is an area configured for storing extra heroes (virtual pieces) by an ally in an auto chess. A hero in the preparation area does not participate in the combat, but may be operated by a player to enter an allied deployment area after the combat ends (a preparation stage), to become a hero participating in the combat in a next turn. The preparation area is configured for providing the player with an additional hero storage site, so as to combine heroes and make fetters during the auto chess.

The preparation area includes several candidate piece positions, and the candidate piece positions are configured for placing candidate pieces. The candidate pieces do not participate in a battle during the combat and may be dragged and placed in a combat area in the preparation stage.

Regarding an arrangement manner of piece positions in the combat area, in some embodiments, the combat area includes n (rows)×m (columns) piece positions. Exemplarily, n is an integer multiple of 2, and two adjacent rows of piece positions are aligned, or two adjacent rows of the piece positions are staggered. In addition, the combat area is evenly divided into two parts based on the rows, which respectively are an allied combat area and an enemy combat area. Users participating in the battle are respectively located on an upper side and a lower side of a battle interface. In the preparation stage, the users may only place pieces in the allied combat area. In some other embodiments, the combat area is evenly divided into two parts based on the columns, which respectively are an allied combat area and an enemy combat area. Users participating in the battle are respectively located on a left side and a right side of a battle interface. A shape of a piece position may be any one of a square, a rectangle, a circle, and a hexagon. The shape of the piece position is not limited in the embodiments of this application.

In some embodiments, the piece positions are always displayed on a board. In some other embodiments, the piece positions are displayed when the user arranges combat pieces. After the combat pieces are placed on the piece positions, the piece positions are removed.

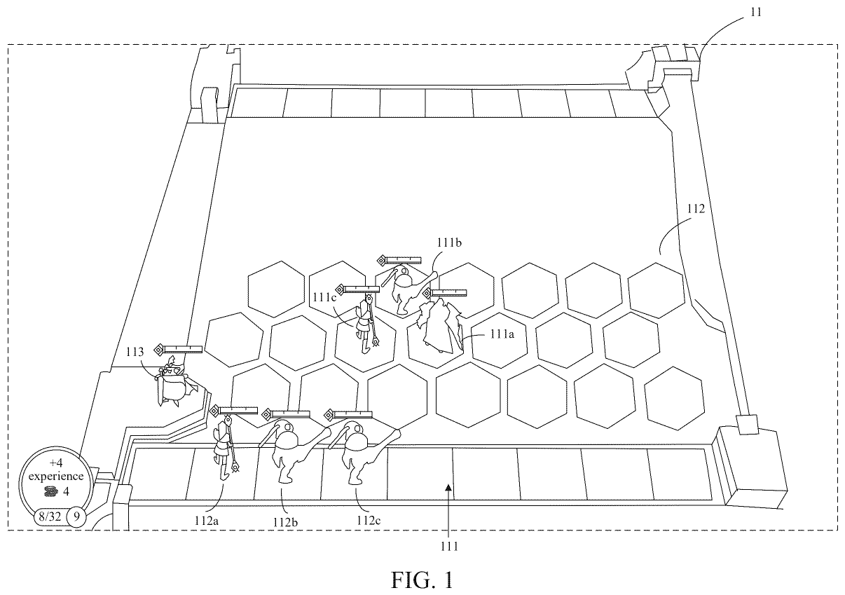

Exemplarily, as shown in FIG. 1, a battle board 11 in the battle interface includes a preparation area 111 and a combat area 112. The allied combat area in the combat area 112 includes 3×7 piece positions, the shape of the piece position is the hexagon, two adjacent rows of the piece positions are staggered, and the battle preparation area 111 includes 9 candidate piece positions.

Virtual piece: It refers to a virtual object placed on a board in a turn-based board game, including a combat piece, a candidate piece, and a piece sold in a store. The combat piece includes a piece located on a combat area and the candidate piece includes a piece located on a preparation area. The virtual piece may be a virtual character, a virtual person, a virtual animal, a cartoon character, or the like. The virtual piece may be displayed through a 3D model.

In some embodiments, a position of the combat piece on the board may be changed. In the preparation stage, a user may adjust a position of the virtual piece in the combat area, adjust a position of the virtual piece in the preparation area, move the virtual piece in the combat area to the preparation area (when an idle candidate piece position exists in the preparation area), or move the virtual piece in the preparation area to the combat area. In the combat stage, the position of the virtual piece located in the preparation area can also be adjusted.

In some embodiments, in the combat stage, the position of the virtual piece in the combat area differs from that in the preparation stage. In the combat stage, a game application automatically controls the virtual piece in the combat area to move and battle in the combat area. For example, in the combat stage, the virtual piece can automatically move from an allied combat area to an enemy combat area and attack a virtual piece of the enemy. Alternatively, the virtual piece may automatically move from a position A of the allied combat area to a position B of the allied combat area. The position A is different form the position B.

Additionally, in the preparation stage, virtual pieces can only be set in the allied combat area (an allied deployment area).

Regarding a method for obtaining the combat piece, in some embodiments, the user can purchase the virtual piece in a store with a gold coin in the preparation stage during a battle.

In some embodiments, a player virtual character is configured to represent the user participating in the battle. The virtual character may be the virtual person, the virtual animal, the cartoon character, or the like. In the following embodiments, such virtual characters are named as player virtual characters or user virtual characters.

Exemplarily, as shown in FIG. 1, a first combat piece 111a, a second combat piece 111b, and a third combat piece 111c are displayed in a combat area 112, and a first candidate piece 112a, a second candidate piece 112b, and a third candidate piece 112c are displayed in a battle preparation area 111. A player virtual character 113 is displayed beside the combat area and the preparation area.

Attribute: Each virtual piece in a turn-based board game has an attribute, and the attribute includes at least two of the following attributes: a camp of a virtual piece (for example, an alliance A, an alliance B, and a neutral faction), a type of a virtual piece (for example, a warrior, a shooter, a master, an assassin, a guard, a swordsman, a gunner, and a fighter), an attack type of a virtual piece (for example, a spell attack and a physical attack), an identity of a virtual piece (for example, a noble, a demon, and a fairy), and the like. In the embodiments of this application, specific types of attributes are not limited. In some embodiments, each virtual piece has attributes in at least two dimensions, and equipment carried by the virtual piece may improve the attributes of the virtual piece.

Fetter: It is a mechanism of an auto chess, and is configured for enhancing a battle effect of selecting a specific virtual piece by a player. The fetter not only can improve game playability, but also can arouse enthusiasm and challenge feeling of the player to a game.

For example, a fetter mechanism of the auto chess may be based on the following three manners.

Character category fetter: When the player has the same piece character type simultaneously, this type of fetter effect is activated. For example, having three orcish pieces may increase a skill deceleration effect thereof, and having six fairy pieces may enable the skills of fairies to take effect one additional time.

Character attack fetter: When the player has the virtual piece of the same character attack type simultaneously, this type of fetter effect is activated. For example, having two master pieces may increase skill damage thereof, and having four master pieces may make the skills thereof irrelevant to enemy resistance.

Character combination fetter: When the player has all virtual pieces corresponding to a character combination simultaneously, this type of fetter effect is activated. For example, having a virtual piece A, a virtual piece B, and a virtual piece C may increase skill damage thereof, and having the virtual piece A, the virtual piece B, the virtual piece C, and a virtual piece D may make the skills of thereof irrelevant to enemy resistance.

The fetter is activated by going to the field. A larger quantity of the fetters on the field (a combat area) indicates higher bonus strength provided by the fetter (the fetter is increased based on a quantity of layers. For every N pieces entered, the quantity of layers is increased by one layer, and the bonus strength is increased by a specific strength. When a quantity of players on the field does not reach one layer, the strength is not affected).

The fetter effect may improve attributes and skills of pieces, so that the pieces are more powerful and effective. The player may reasonably select and match the pieces, so as to achieve a higher fetter effect and enhance a battle capability of a team. Therefore, the fetter mechanism is a very important part of the auto chess.

For example, in the combat area, when different virtual pieces have associated attributes (that different virtual pieces have the same attribute, or different virtual pieces have complementary types of attributes are included), and a quantity reaches a quantity threshold (or referred to as the fetter), a pair of virtual pieces having these attributes or all the virtual pieces in the combat area may obtain a gain effect corresponding to the attributes. For example, when the combat area includes 2 pieces with a warrior attribute simultaneously, all combat pieces obtain 10% defensive power bonus. When the combat area includes 4 battle pieces with a warrior attribute simultaneously, all combat pieces obtain 20% defensive power bonus. When the combat area includes 3 pieces with a fairy attribute simultaneously, all combat pieces obtain 20% evasion probability bonus.

Store: It is a place in which a user may spend a virtual resource (a gold coin) in a game to purchase a virtual piece (a hero). Generally, 5 random heroes (repeatable) are displayed in the store. Stores are distinguished by levels. A higher level indicates a higher probability of refreshing a high-grade hero. Generally, an initial level is 1 to 3 (levels of different auto chess games are different), and the user may spend gold coins to upgrade the store.

User interface (UI) control: It is a visible control or element or an invisible control or element on a UI of an application, such as a picture, an input box, a text box, a button, and a label. Exemplarily, when the UI control is the invisible control, the user may trigger the invisible control by triggering a specified area on the UI. Some UI controls respond to user operations, for example, purchase controls are configured to respond to user purchase operations to purchase corresponding pieces. An upgrade control is configured to upgrade a store.

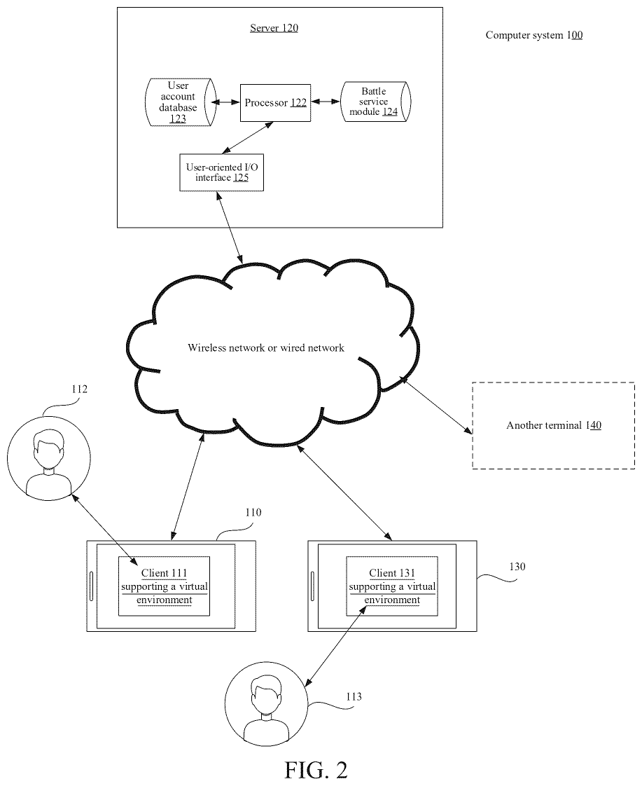

FIG. 2 is a structural block diagram of a computer system according to an exemplary embodiment of this application. The computer system 100 includes a first terminal 110, a server 120, and a second terminal 130.

The first terminal 110 has a client 111 supporting a virtual environment installed and running therein. The client 111 may be a client of a turn-based board game program. When the first terminal runs the client 111, a UI of the client 111 is displayed on a screen of the first terminal 110. The client may be a client of an auto chess game. The first terminal 110 is a terminal used by a first user 112. In a preparation stage of a battle, the first user uses the first terminal 110 to arrange battle pieces in a combat area of a board. In a battle stage, the first terminal 110 or the server 120 automatically controls the battle pieces to battle based on attributes, skills, and arrangements of the combat pieces in the combat area. The terminal in the embodiments of this application may also be referred to as a terminal device, and a computer device in the embodiments of this application may be implemented as the terminal device. The foregoing virtual environment refers to a virtual scene displayed or provided by the client 111 during running. The virtual environment may be a simulated environment of a real environment, may be a semi-simulated and semi-fictional environment, or may be a purely fictional environment. The virtual environment may include at least one of the following: a 2D virtual environment, a 2.5D virtual environment, and a 3D virtual environment.

The second terminal 130 has a client 131 supporting a virtual environment installed and running therein. The client 131 may be a client of a turn-based board game program. When the second client 131 runs in the second terminal 130, a UI of the second client 131 is displayed on a screen of the second terminal 130. The client may be a client of an auto chess game. The second terminal 130 is a terminal used by a second user 113. The second terminal 130 is a terminal used by a second user 113. In a preparation stage of a battle, the second user uses the second terminal 130 to arrange combat pieces in a combat area of a board. In a battle stage, the second terminal 130 or the server 120 automatically controls the combat pieces to battle based on attributes, skills, and arrangements of the combat pieces in the combat area.

In some embodiments, the combat pieces arranged by the first user through the first terminal 110 and arranged by the second user through the second terminal 130 are located in different combat areas on the same board. In other words, the first user and the second user are on the same board in the same battle. Alternatively, the combat pieces arranged by the first user through the first terminal 110 and arranged by the second user through the second terminal 130 are located on different boards. In other words, the first user and the second user are on different boards in the same battle. In an exemplary embodiment, a battle of the turn-based board game is played by eight user accounts. In each round, the eight user accounts are matched in pairs. Two user accounts that are matched to battle on the same board in a current round.

In some embodiments, the client installed in the first terminal 110 is same as the client installed in the second terminal 130, or the clients installed in the two terminals are clients of the same type on different operating system platforms (Android or IOS). The first terminal 110 may be one of a plurality of terminals, and the second terminal 130 may be another of the plurality of terminals. In this embodiment, only the first terminal 110 and the second terminal 130 are used as an example for description. The first terminal 110 and the second terminal 130 are of the same device type or different device types. The device type includes at least one of a smartphone, a tablet computer, an e-book reader, a moving picture experts group audio layer III (MP3) player, a moving picture experts group audio layer IV (MP4) player, an intelligent robot, an on-board terminal, a laptop, and a desktop computer. In the following embodiment, a description is provided by using an example in which the terminal includes a smartphone.

A person skilled in the art may understand that more or fewer terminals may be provided. For example, only one of the foregoing terminals (in other words, the user and artificial intelligence (AI) to play a battle) may be included. Alternatively, 8 (lvlvlvlvlvlvlvl, a round battle and elimination is performed among the 8 users, and a final winner is determined) or more of the foregoing terminals may be included. A quantity of terminals and a device type are not limited in the embodiments of this application.

FIG. 2 shows only two terminals. However, in a different embodiment, a plurality of other terminals 140 exist and may be connected to the server 120. In some embodiments, one or more terminals 140 corresponding to a developer alternatively exist. A development and editing platform of the client supporting the virtual environment is installed on each of the terminals 140. The developer may edit and update the client on the terminals 140, and transmit an updated client installation package to the server 120 through a wired or wireless network. The first terminal 110 and the second terminal 130 may download the client installation package from the server 120 to update the client.

The first terminal 110, the second terminal 130, and the other terminals 140 are connected to the server 120 through the wired network or the wireless network.

The server 120 includes at least one of one server, a plurality of servers, a cloud computing platform, and a virtualization center. The server 120 is configured to provide a backend service for the client supporting the virtual environment (a client of the turn-based board game/a client of the auto chess game). In some embodiments, the server 120 is in charge of primary computing, and the terminals are in charge of secondary computing. Alternatively, the server 120 is in charge of the secondary computing, and the terminals are in charge of the primary computing. Alternatively, the server 120 and the terminal perform collaborative computing based on a distributed computing architecture.

In an example, the server 120 includes a processor 122, a user account database 123, a battle service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal 110, the second terminal 130, and the other terminals 140, for example, avatars of the user accounts, nicknames of the user accounts, combat effectiveness indices of the user accounts, and service regions where the user accounts are located. The battle service module 124 is configured to provide a plurality of battle rooms for battles between users. The user-oriented I/O interface 125 is configured to establish communication with the first terminal 110 or the second terminal 130 through the wireless network or the wired network to exchange data.

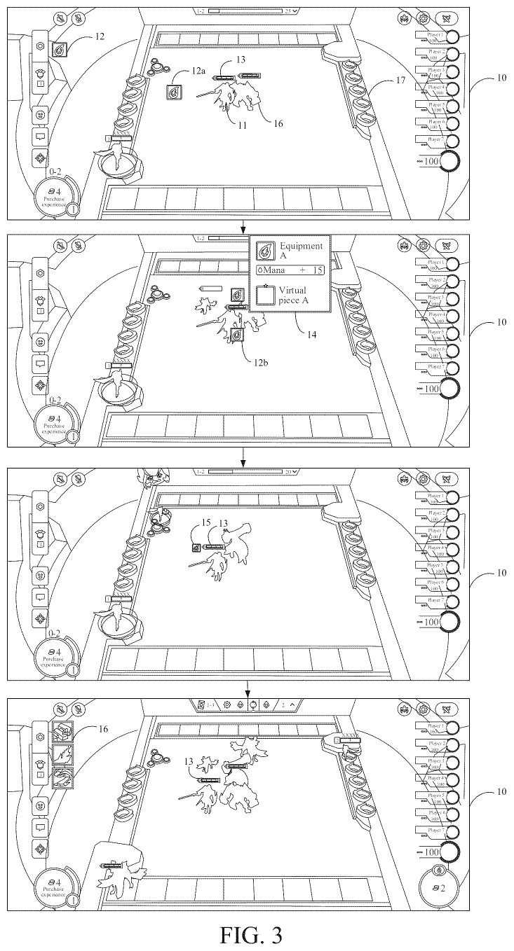

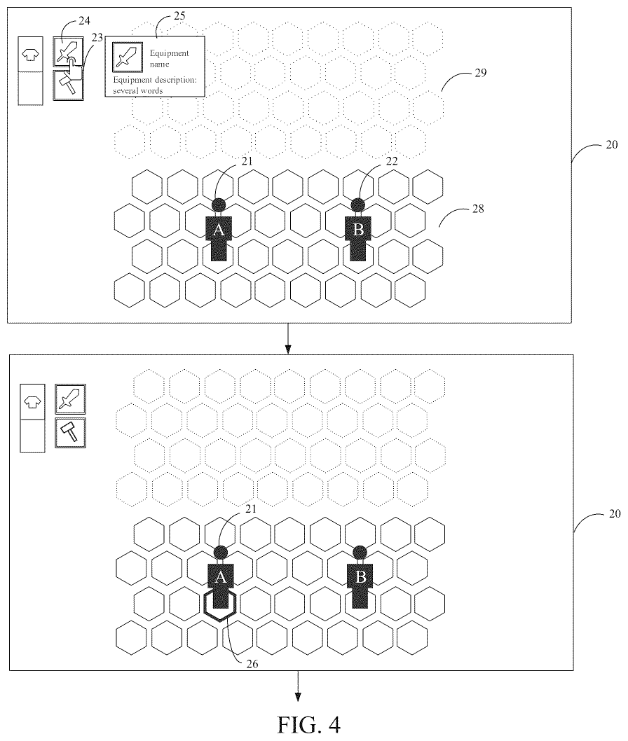

In some embodiments, a general rule exists in the turn-based board game. In other words, a performance of virtual pieces in the battle is improved by providing equipment for the virtual pieces. FIG. 3 is a schematic diagram of an interface for an equipment providing method for a virtual piece in the related art. As shown in FIG. 3, a battle board 17 is displayed on a battle interface 10, and the battle board 17 includes an allied virtual piece 11 and an enemy virtual piece 16 during a battle. A hit point bar 13 of the allied virtual piece is displayed on an upper side of the allied virtual piece 11. Equipment 12 in an equipment bar is displayed in an upper left of the battle interface 10. After selecting the equipment 12, the player drags the equipment 12 to a position of the allied virtual piece 11. FIG. 3 shows that after the equipment 12 is dragged to a position 12b where the allied virtual piece 11 is located through a middle position 12a, the battle interface 10 displays a providing information card 14, and the providing information card 14 displays a name of the equipment 12 to be provided, a function of the equipment 12, and a name of the allied virtual piece 11. After the player releases, the equipment 12 is provided for the allied virtual piece 11, and an equipment identifier 15 of the equipment 12 is displayed in front of the hit point bar 13 of the allied virtual piece. When the player needs to remove the equipment 12 from the allied virtual piece 11, the player needs to remove the equipment when a disassembler 16 exists in the equipment bar. In other words, the disassembler 16 in the equipment bar is dragged to the allied virtual piece 11 to remove the equipment 12, and then the equipment identifier 15 of the equipment 12 is removed before the hit point bar 13 of the allied virtual piece.

In a process of providing the allied virtual piece by dragging the equipment, when a plurality of virtual pieces are arranged densely on a battle board, an accidental touch is easily caused. In other words, the equipment is provided for an incorrect virtual piece, resulting in low equipment providing efficiency and low human-computer interaction efficiency of the virtual pieces during a battle. In addition, operations of switching equipment between the virtual pieces in the related art include first disassembling the equipment of the virtual piece A, and then dragging the equipment selected from the equipment bar and disassembled from the virtual piece A to the virtual piece B in a manner shown in FIG. 3. The process has complex operations and the equipment has a long providing time, which may prolong layout time of the player, and s layout efficiency is low, resulting in low battle efficiency.

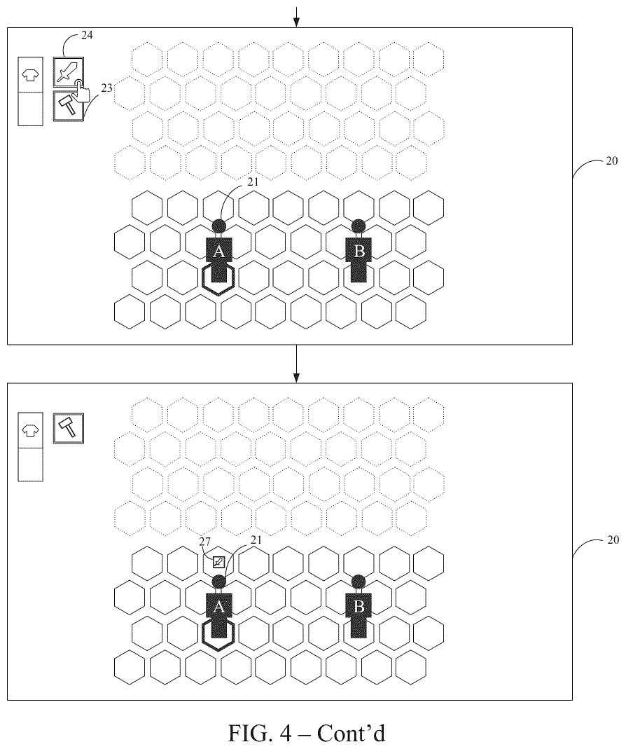

FIG. 4 is a schematic diagram of an interface for an equipment providing method for a virtual piece according to an exemplary embodiment of this application. On a battle board in a battle interface 20, a battle area is divided into an allied area 28 (in other words, the foregoing allied deployment area) and an enemy area 29. The allied area 28 includes a virtual piece A 21 and a virtual piece B 22. An equipment bar 23 is displayed in an upper left corner of the battle interface 20. In a normal mode (i.e., a mode in which a virtual piece is not selected for equipment providing), equipment in the equipment bar 23 is clicked/tapped, and an information card of the equipment is displayed. For example, equipment 24 in the equipment bar 23 is clicked/tapped, and an information card 25 of the equipment 24 is displayed. The information card 25 includes a name of the equipment 24 and equipment description. When the virtual piece A 21 is provided, the virtual piece A 21 is clicked/tapped, and a piece position 26 of the virtual piece A 21 in a selected state is displayed in bold, so as to show that the virtual piece A 21 is in the selected state. Next, the equipment 24 in the equipment bar 23 is clicked/tapped, the equipment 24 is provided for the virtual piece A 21, and an identifier icon 27 of the equipment 24 is displayed on an upper side of the virtual piece A 21. In other words, provision of the equipment 24 of the virtual piece A 21 is completed.

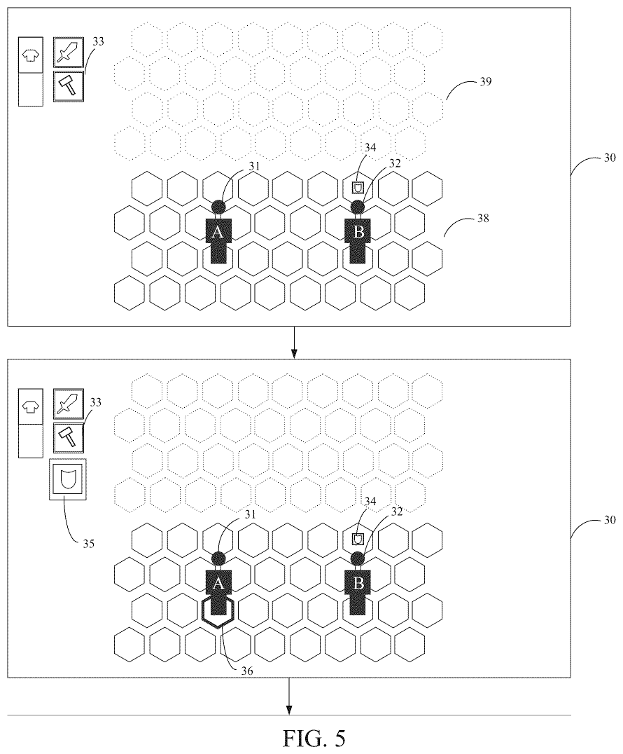

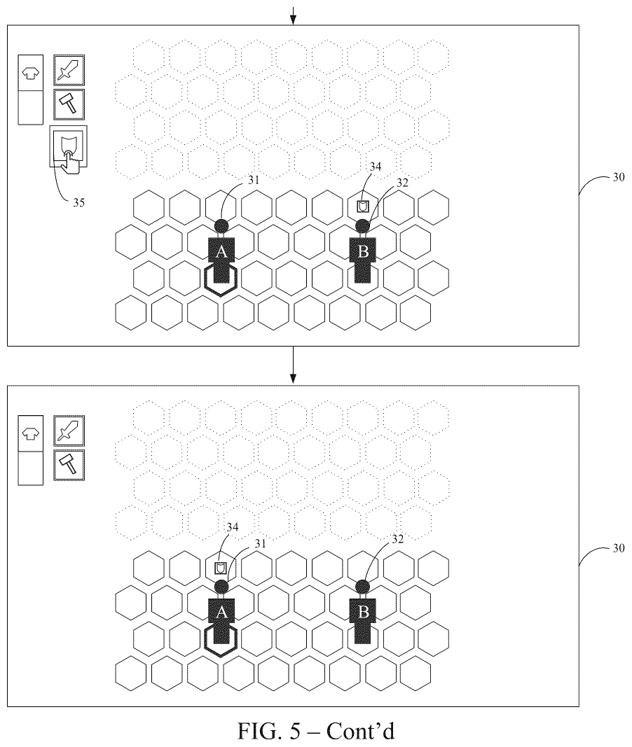

FIG. 5 is a schematic diagram of an interface for an equipment providing method for a virtual piece according to another exemplary embodiment of this application. A battle area is divided into an allied area 38 and an enemy area 39 on a battle board in a battle interface 30. The allied area 38 includes a virtual piece A 31 and a virtual piece B 32. An identifier icon 34 of equipment 35 is displayed on a head of the virtual piece B 32, indicating that the virtual piece B 32 is provided with the equipment. An equipment bar 33 is displayed in an upper left corner of the battle interface 30. When the virtual piece A 31 is provided, the virtual piece A 31 is clicked/tapped, and a piece position 36 of the virtual piece A 31 in a selected state is displayed in bold, so as to show that the virtual piece A 31 is in a selected state. The equipment 35 provided with the virtual piece B 32 is newly displayed in the equipment bar 33. After the equipment 35 in the equipment bar 33 is clicked/tapped, the equipment 35 is provided for the virtual piece A 31, the identifier icon 34 of the equipment 35 is displayed on an upper side of the virtual piece A 31, and the identifier icon 34 is removed on an upper side of the virtual piece B 32. In other words, switching of the equipment 35 from the virtual piece B 32 to the virtual piece A 31 is completed.

It may be seen from FIG. 4 to FIG. 5 that in the method provided in the embodiments of this application, by selecting a first virtual piece, and selecting the equipment that is intended to be provided for the first virtual piece through the equipment bar, the equipment of the first virtual piece can be quickly and precisely provided, the equipment can be conveniently switched between different virtual pieces, providing time of the equipment is shortened, and efficiency of human-computer interaction is improved.

With reference to the above description of the turn-based board game and the description of implementation environment, an equipment providing method for a virtual piece provided in the embodiments of this application is described. A description is provided by using an example in which the method is performed by the terminal shown in FIG. 2 or the client running on the terminal. The client running on the terminal is a client of an application, and the application is a program for the turn-based board game.

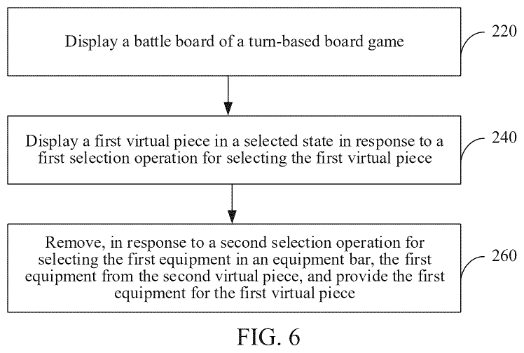

FIG. 6 is a flowchart of an equipment providing method for a virtual piece according to an exemplary embodiment of this application. The method may be performed by any terminal in FIG. 2 above or a client running on any terminal. The client is a client of a turn-based board game. The client is logged with a first account. The method includes the following operations.

Operation 220: Display a battle board of a turn-based board game.

The battle board refers to areas configured for preparing and performing a battle in a battle interface of the turn-based board game, and the battle board is divided into a combat area and a preparation area. The combat area is configured for placing a virtual piece participating in the turn-based board game battle, and the preparation area is an area in which an extra virtual piece is stored.

Exemplarily, the battle board of the turn-based board game is displayed on the battle interface of the turn-based board game, the battle board includes a first virtual piece and a second virtual piece controlled by the first account, and the second virtual piece is provided with first equipment. The first account refers to a user account that is currently logged in to a client, and the user account may refer to an account registered by a user in the turn-based board game. The first virtual piece may be any virtual piece provided by the turn-based board game, the second virtual piece may be another virtual piece provided by the turn-based board game, and the first virtual piece is different from the second virtual piece. The first equipment may be any virtual equipment provided by the turn-based board game, and the virtual equipment may be configured to change an attribute, an appearance, and the like of the virtual piece.

For example, as shown in FIG. 5, the battle board of the turn-based board game is displayed in the battle interface 30. The battle board includes an allied area 38 and an enemy area 39. The battle board includes a first virtual piece (for example, a virtual piece A 31) and a second virtual piece (for example, a virtual piece B 32) controlled by the first account. The second virtual piece is provided with the first equipment (for example, equipment 35).

In some embodiments, the battle board may further include other virtual pieces (not exceeding an upper limit of a quantity of virtual pieces that may be battled) controlled by the first account. All virtual pieces in the combat area may be referred to as combat pieces, and all virtual pieces in the battle preparation area may be referred to as candidate pieces. The foregoing first virtual piece and the second virtual piece may be the combat pieces.

Operation 240: Display the first virtual piece in a selected state in response to a first selection operation for selecting the first virtual piece.

The first selection operation is used as an operation of selecting a virtual piece. The first selection operation may be implemented as at least one of a clicking/tapping operation, a double-clicking operation, a voice operation, a pressure touch operation, an eye control, and a somatosensory control, which is not limited in this embodiment of this application. In some embodiments, the operation in this embodiment of this application may be triggered by a display (such as a touch display) of a terminal or an external device (such as a mouse, a keyboard, or a joystick). For example, the clicking/tapping operation may be triggered by the touch display of the terminal, and the somatosensory control may be triggered by the external device of the terminal.

Exemplarily, when the first selection operation is the clicking/tapping operation, the client displays the first virtual piece in a selected state in response to the first clicking/tapping operation performed by the user on the first virtual piece. The selected state refers to a state in which the virtual piece is selected, and the first virtual piece in a selected state may be subject to related operations by the user, such as displacing, providing equipment, and viewing information.

In an example, the client highlights the first virtual piece in a selected state, to indicate that the first virtual piece is in the selected state, and the first virtual piece in a selected state may be presented as at least one of the following: the first virtual piece whose color is highlighted, the first virtual piece whose appearance line is bold, the first virtual piece with a shadow, the first virtual piece on which animation is displayed, the first virtual piece on which a character motion corresponding to a virtual piece is displayed, the first virtual piece on which a sound effect is played, color of a piece position where the first virtual piece is located is highlighted, a line of the piece position where the first virtual piece is located is bold, and the piece position where the first virtual piece is located is shaded.

For example, as shown in FIG. 5, the client displays a piece position 36 of the first virtual piece in a selected state in bold in response to the first selection operation for the first virtual piece (the virtual piece A 31), so as to show that the first virtual piece is in the selected state.

In some embodiments, when an equipment bar is not displayed on the battle interface, the client displays the equipment bar in response to the first selection operation for the first virtual piece. The equipment bar is configured for displaying equipment owned by the first account in a game battle. For example, the equipment bar may be configured for displaying equipment that is provided and equipment that is not provided. A display position and a display style of the equipment bar are not limited in the embodiments of this application. For example, referring to FIG. 4, the client displays the equipment bar 23 at an upper left corner of the battle interface 20, and each equipment in the equipment bar 23 is presented in a column.

Alternatively, when the equipment bar in an equipment-unselectable state is displayed on the battle interface, the equipment bar is switched to an equipment-switching state in response to the first selection operation for selecting the first virtual piece, the equipment-switching state is configured for indicating that the equipment in the equipment bar is in a selectable state, and the equipment-unselectable state being is configured for indicating that the equipment in the equipment bar is in an unselectable state. In some embodiments, different from the equipment bar in the equipment-unselectable state, the client highlights the equipment bar in the equipment-switching state. For example, the client converts the equipment bar from a gloomy state (the equipment-unselectable state) to a highlighted state (the equipment-switching state), or converts the equipment in the equipment bar from the gloomy state to the highlighted state, which is not limited in this embodiment of this application.

Further alternatively, when only equipment belonging to the first account and provided with no any virtual piece on the battle board is displayed in the equipment bar, the client additionally displays equipment provided with virtual pieces other than the first virtual piece in the equipment bar in response to the first selection operation for selecting the first virtual piece. For example, referring to FIG. 5, when the equipment bar 33 only displays equipment that is not provided, in response to the first selection operation for selecting the first virtual piece (the virtual piece A 31), the client additionally displays the equipment 35 provided with the second virtual piece (the virtual piece B 32) in the equipment bar 33.

In some embodiments, the equipment bar includes a first equipment bar and a second equipment bar. The client displays the first equipment bar and the second equipment bar that are in the equipment-switching state in response to the first selection operation for selecting the first virtual piece. The first equipment bar is configured for displaying first to-be-selected equipment belonging to the first account and provided with no any virtual piece, each equipment in the first equipment bar in the equipment-switching state is in the selectable state, and the first to-be-selected equipment generally refers to equipment that is not provided. The second equipment bar is configured for displaying second to-be-selected equipment belonging to the first account and provided with a virtual piece other than the first virtual piece. The second to-be-selected equipment includes the first equipment. Each equipment in the second equipment bar in the equipment-switching state is in the selectable state, and the second to-be-selected equipment generally refers to equipment that is provided. Through the first equipment bar and the second equipment bar, the provided equipment and the equipment that has not been provided may be effectively distinguished, thereby quickly determining whether to perform an equipment providing process or an equipment switching process, thereby improving human-computer interaction efficiency.

In an example, the client displays the first equipment bar. The client additionally displays the second equipment bar in response to the first selection operation for selecting the first virtual piece, and switches the first equipment bar and the second equipment bar from the equipment-unselectable state to the equipment-switching state.

Operation 260: Remove, in response to a second selection operation for selecting the first equipment in an equipment bar, the first equipment from the second virtual piece, and provide the first equipment for the first virtual piece.

The second selection operation is used as an operation of selecting equipment. The second selection operation may be implemented as at least one of a clicking/tapping operation, a double-clicking operation, a voice operation, a pressure touch operation, an eye control, and a somatosensory control, which is not limited in this embodiment of this application.

Exemplarily, when the second selection operation is the clicking/tapping operation, a client undisplays, in response to a second clicking/tapping operation for selecting the first equipment in the equipment bar, the first equipment on the second virtual piece, and displays the first virtual piece provided with the first equipment. In other words, the first equipment provided for the second virtual piece is migrated to the first virtual piece. The first selection operation and the second selection operation are set as the clicking/tapping operation, and compared with a dragging operation, selection of the virtual piece and the equipment may be caused to be more convenient, thereby effectively improving equipment providing efficiency of the virtual piece.

For example, as shown in FIG. 5, after the first equipment (the equipment 35) in the equipment bar 33 is clicked/tapped, the first equipment is provided for the first virtual piece (the virtual piece A 31), the identifier icon 34 of the first equipment is displayed on an upper side of the first virtual piece, and the identifier icon 34 is removed on an upper side of the second virtual piece (the virtual piece B 32). In other words, migration of the first equipment from the second virtual piece to the first virtual piece is completed.

In some embodiments, the equipment bar includes a first equipment bar and a second equipment bar. In response to a second selection operation for selecting the first equipment in a second equipment bar, the first equipment is removed from the second virtual piece, and the first equipment is provided for the first virtual piece. The first equipment bar is configured for displaying first to-be-selected equipment belonging to the first account and provided with no any virtual piece. The second equipment bar is configured for displaying second to-be-selected equipment belonging to the first account and provided with a virtual piece other than the first virtual piece. The second to-be-selected equipment includes the first equipment.

In other words, after the first virtual piece is selected through the first selection operation, the first equipment provided for the second virtual piece is displayed in the second equipment bar, and the first equipment is migrated from the second virtual piece to the first virtual piece through the second selection operation on the first equipment in the second equipment bar.

In some embodiments, after the migration of the first equipment from the second virtual piece to the first virtual piece is implemented, equipment providing for the first virtual piece may be exit by clicking/tapping a blank area of the battle board or clicking/tapping the first virtual piece again. In other words, the first virtual piece in an unselected state is displayed in response to a third selection operation for selecting a blank area of the battle board after the first virtual piece is provided with the equipment. The unselected state refers to a state in which the virtual piece is not selected, and the first virtual piece in an unselected state may not be subject to related operations by the user. Alternatively, the first virtual piece in the unselected state is displayed in response to the first selection operation for selecting the first virtual piece again after the first virtual piece is provided with the equipment. The third selection operation is used as an operation of deselecting a virtual piece. The third selection operation may be implemented as at least one of a clicking/tapping operation, a double-clicking operation, a voice operation, a pressure touch operation, an eye control, and a somatosensory control. The virtual piece may be quickly switched out of the selected state through the third selection operation and the first selection operation, and equipment providing for the virtual pieces may be exit, thereby improving efficiency of human-computer interaction.

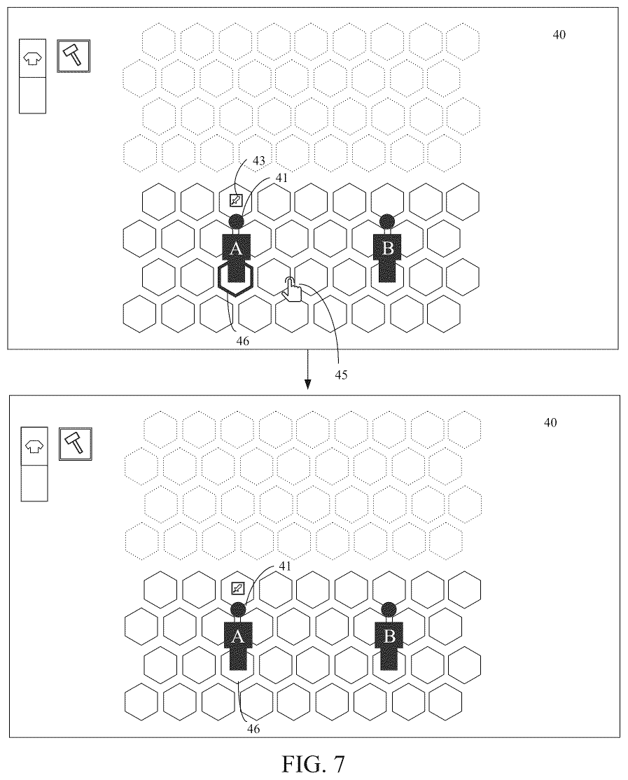

For example, as shown in FIG. 7, a first virtual piece 41 on which the provision is completed is displayed on a battle interface 40, an identifier icon 43 of the provided equipment is displayed on an upper side of the first virtual piece, and a piece position 46 where the first virtual piece 41 is located is displayed in bold, to show that the first virtual piece 41 is in a selected state. In response to that the user clicks/taps the blank area 45 of the battle board (an area without a virtual piece on the battle board or outside the battle board) or clicks/taps the first virtual piece 41 again, the client displays the first virtual piece 41 in an unselected state, and undisplays the piece position 46 in bold, so as to exit the equipment providing for the first virtual piece.

In some other embodiments, after the migration of the first equipment from the second virtual piece to the first virtual piece is implemented, an object for providing equipment may be switched by selecting the allied virtual piece other than the first virtual piece. In other words, the client displays, in response to a first selection operation for selecting the third virtual piece, the third virtual piece in the selected state, and displays the first virtual piece in the unselected state after the first virtual piece is provided with the equipment, the third virtual piece being a virtual piece controlled by the first account other than the first virtual piece. When the first virtual piece is selected, another virtual piece can be switched to select through the first selection operation for the another virtual piece, so as to implement rapid switching between virtual pieces, thereby improving switching efficiency of the virtual pieces, and further improving efficiency of human-computer interaction.

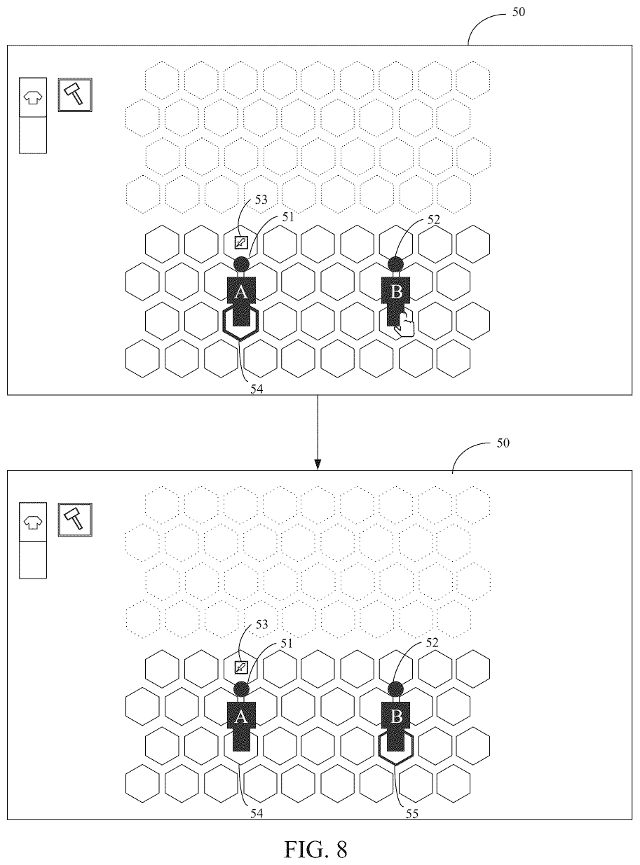

For example, as shown in FIG. 8, a first virtual piece 51 on which the provision is completed is displayed on a battle interface 50, an identifier icon 53 of the provided equipment is displayed on an upper side of the first virtual piece, and a piece position 54 where the first virtual piece 51 is located is displayed in bold, to show that the first virtual piece 51 is in a selected state. In response to that the user clicks/taps the third virtual piece 52, the client displays the first virtual piece 51 in an unselected state and displays the third virtual piece 52 in a selected state. In other words, the client undisplays the piece position 54 where the first virtual piece 51 is located in bold and displays a piece position 55 where the third virtual piece 52 is located in bold, so as to indicate switching from a providing state of the first virtual piece 51 to a providing state of the third virtual piece 52. The providing state refers to a state in which the equipment provision may be performed.

Based on the above, according to the method provided in the embodiments of this application, in an equipment process of providing the virtual piece, equipment to be provided for the virtual pieces can be selected in the equipment bar only by selecting the virtual piece, thereby quickly providing the virtual piece, avoiding redundant operations of first disassembling and then dragging and providing the equipment, saving operation costs, and improving equipment providing efficiency of the virtual piece. In addition, when the virtual pieces on the battle board are dense, accidental touches easily caused by dragging the equipment to the virtual pieces may be effectively avoided, and the equipment of the virtual pieces may be accurately provided, thereby improving equipment providing accuracy of the virtual pieces.

In addition, after the first virtual piece is selected, the equipment provided on the second virtual piece in the equipment bar is selected, so that the first virtual piece is provided with the equipment, which implements fast switching of the equipment between the virtual pieces, avoids redundant operations of first disassembling the equipment and then re-providing the equipment, and saves operation costs, thereby improving human-computer interaction efficiency. In addition, through fixed-point provision of equipment, the accidental touches during equipment dragging are avoided, the providing time of the equipment is shortened, and the battle efficiency is improved.

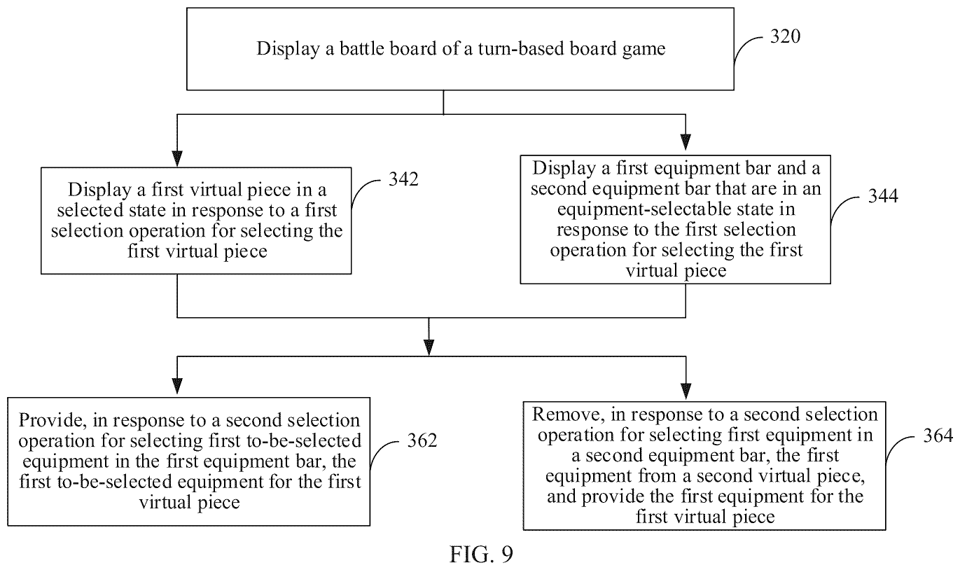

FIG. 9 is a flowchart of an equipment providing method for a virtual piece according to an exemplary embodiment of this application. The method may be performed by any terminal in FIG. 2 above or a client running on any terminal. The client is a client of a turn-based board game. The client is logged with a first account. In an embodiment shown in FIG. 9, the equipment bar includes a first equipment bar and a second equipment bar. The first equipment bar is configured for displaying first to-be-selected equipment belonging to the first account and provided with no any virtual piece. The second equipment bar is configured for displaying second to-be-selected equipment belonging to the first account and provided with a virtual piece other than the first virtual piece. The second to-be-selected equipment includes the first equipment provided by the second virtual piece. For content not described in this embodiment of this application, reference may be made to the foregoing embodiments. The method includes the following operations.

Operation 320: Display a battle board of a turn-based board game.

The battle board refers to areas configured for preparing and performing a battle in a battle interface of the turn-based board game, and the battle board is divided into a combat area and a preparation area. The combat area is configured for placing a virtual piece participating in the turn-based board game battle, and the preparation area is an area in which an extra virtual piece is stored.

Exemplarily, a battle board of the turn-based board game is displayed on the battle interface, the battle board includes a first virtual piece and a second virtual piece controlled by a first account, and the second virtual piece is provided with first equipment. For example, as shown in FIG. 5, the battle board of the turn-based board game is displayed in the battle interface 30. The battle board includes the allied area 38 and the enemy area 39. The battle board includes the first virtual piece (for example, the virtual piece A 31) and the second virtual piece (for example, the virtual piece B 32) controlled by the first account. The second virtual piece is provided with the first equipment (for example, the equipment 35).

Operation 342 and operation 344 are performed below, but a sequence is not performed.

Operation 342: Display the first virtual piece in a selected state in response to a first selection operation for selecting the first virtual piece.

The first selection operation is used as an operation of selecting a virtual piece. The first selection operation may be implemented as at least one of a clicking/tapping operation, a double-clicking operation, a voice operation, a pressure touch operation, an eye control, and a somatosensory control, which is not limited in this embodiment of this application.

Exemplarily, when the first selection operation is the clicking/tapping operation, the client displays the first virtual piece in a selected state in response to a first clicking/tapping operation for the first virtual piece.

The first virtual piece in the selected state may be manifested as at least one of the following: the first virtual piece whose color is highlighted, the first virtual piece whose appearance line is bold, the first virtual piece with a shadow, the first virtual piece on which animation is displayed, the first virtual piece on which a character motion corresponding to a virtual piece is displayed, the first virtual piece on which a sound effect is played, color of a piece position where the first virtual piece is located is highlighted, a line of the piece position where the first virtual piece is located is bold, and the piece position where the first virtual piece is located is shaded.

For example, as shown in FIG. 5, the client displays the piece position 36 of the first virtual piece in a selected state in bold in response to the first selection operation on the first virtual piece (the virtual piece A 31), so as to show that the first virtual piece is in the selected state.

Operation 344: Display a first equipment bar and a second equipment bar that are in an equipment-switching state in response to the first selection operation for selecting the first virtual piece.

The first selection operation is used as an operation of selecting a virtual piece. The first selection operation may be implemented as at least one of a clicking/tapping operation, a double-clicking operation, a voice operation, a pressure touch operation, an eye control, and a somatosensory control, which is not limited in this embodiment of this application.

The first equipment bar is configured for displaying first to-be-selected equipment belonging to the first account and provided with no any virtual piece. The second equipment bar is configured for displaying second to-be-selected equipment belonging to the first account and provided with a virtual piece other than the first virtual piece. The second to-be-selected equipment includes the first equipment.

The equipment-switching state refers to that equipment in the equipment bar is in a selectable state. For example, the equipment bar changes from a gloomy state to a highlighted state. Alternatively, the equipment in the equipment bar changes from an unselectable state to a selectable state.

In some embodiments, in a normal mode (i.e., when equipment provision is not performed on the first virtual piece), the client displays the first equipment bar. In a provision mode (i.e., when the equipment provision is performed on the first virtual piece), the client additionally displays the second equipment bar. Alternatively, the client does not display the equipment bar in the normal mode, and displays the first equipment bar and the second equipment bar in the provision mode.

In some embodiments, when no virtual piece provided with equipment exists, the client displays only the first equipment bar in an equipment-switching state in response to the first selection operation for selecting the first virtual piece. In other words, when an ally has only the first virtual piece on the battle board or when none of the virtual pieces of the ally on the battle board is provided with equipment, the client displays only the first equipment bar in the equipment-switching state after the first virtual piece is selected. In this way, elements in the battle interface can be reduced, simplicity of the battle interface is improved, and the user is helped arrange.

In some embodiments, an arrangement sequence of the equipment in the first equipment bar and the second equipment bar may be arranged randomly. Alternatively, the equipment in the first equipment bar and the second equipment bar are arranged based on a chronological order of obtaining the equipment. Alternatively, the equipment in the first equipment bar and the second equipment bar is sorted based on recommendation priorities determined based on the attribute of the first virtual piece and the attribute of the equipment (for example, sorted in order based on a matching degree between the equipment and the attribute of the first virtual piece; or for another example, sorting in order of the quality of the attributes of the equipment). Alternatively, the equipment in the second equipment bar is correspondingly arranged with the virtual piece provided with the equipment (for example, a plurality of equipment provided with the second virtual piece are arranged together), or the like, which is not limited in this embodiment of this application.

In some embodiments, when at least two allied virtual pieces provided with the equipment other than the first virtual piece exist, all second to-be-selected equipment may be displayed in one second equipment bar, and the second to-be-selected equipment is displayed correspondingly to the allied virtual pieces that is provided with the second to-be-selected equipment. When only one allied virtual piece provided with the equipment other than the first virtual piece exists, a display order of the second to-be-selected equipment is not limited. Alternatively, the equipment bar includes a plurality of second equipment bars, and each second equipment bar corresponds to one virtual piece. For example, a quantity of the second equipment bars is the same as a quantity of allied virtual pieces that are provided with the equipment other than the first virtual piece. In other words, each second equipment bar is configured for displaying one equipment provided with the allied virtual piece that is provided with the equipment other than the first virtual piece.

In some embodiments, in response to the first selection operation for selecting the first virtual piece, the first equipment bar in the equipment-switching state and the second equipment bar whose quantity is the same as a quantity of candidate equipment virtual pieces are displayed, a provided equipment of the candidate equipment virtual pieces corresponding to the second equipment bar being displayed in the second equipment bar, the candidate equipment virtual pieces being virtual pieces provided with at least one equipment other than the first virtual piece, and the candidate equipment virtual pieces including the second virtual piece. One second equipment bar is set for each candidate equipment virtual piece, so that the user can quickly obtain a providing situation of the equipment, which improves information obtaining efficiency and facilitates quick decision of the user, thereby improving user viscosity.

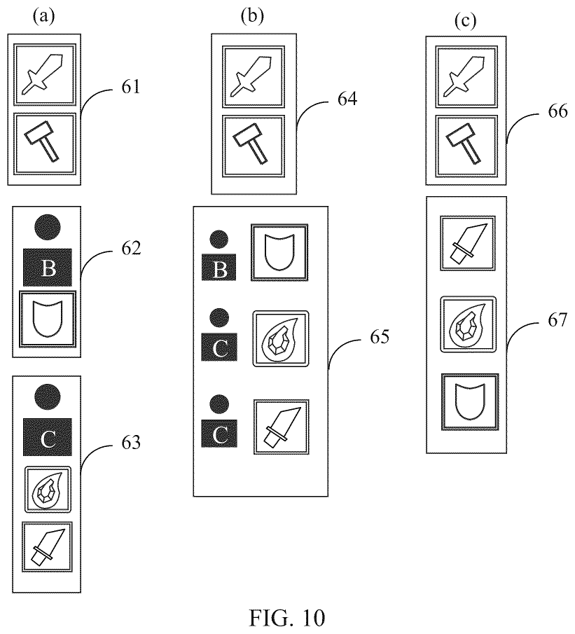

For example, as shown in FIG. 10 (a), an allied virtual piece is provided with a virtual piece B and a virtual piece C. After a first selection operation is performed for the first virtual piece, the client displays a first equipment bar 61 in an equipment-switching state and two second equipment bars in an equipment-switching state. The two equipment bars are respectively a second equipment bar 62 corresponding to the virtual piece B and a second equipment bar 63 corresponding to the virtual piece C.

In some embodiments, the first equipment bar and the second equipment bar that are in an equipment-switching state are displayed in response to the first selection operation for selecting the first virtual piece. The second to-be-selected equipment in the second equipment bar is arranged in an order corresponding to the virtual piece provided with the second to-be-selected equipment.

For example, as shown in FIG. 10 (b), an allied virtual piece is provided with a virtual piece B and a virtual piece C. After a first selection operation is performed for a first virtual piece, the client displays a first equipment bar 64 in an equipment-switching state and a second equipment bar 65 in an equipment-switching state. Equipment displayed in the second equipment bar 65 corresponds to a virtual piece provided with the equipment. In other words, an icon configured for indicating a virtual piece on which the equipment is currently provided is displayed before the equipment, for example, an avatar corresponding to the virtual piece. In this way, the equipment in the second equipment bar and the virtual piece provided with the equipment are correspondingly displayed, so that a user can quickly obtain a providing situation of the equipment when a battle interface is ensured to be simple, thereby improving user experience.

In some embodiments, the first equipment bar and the second equipment bar that are in an equipment-switching state are displayed in response to the first selection operation for selecting the first virtual piece. The first to-be-selected equipment in the first equipment bar is sorted based on a first recommendation priority, and the second to-be-selected equipment in the second equipment bar is sorted based on a second recommendation priority, the first recommendation priority being determined based on an attribute of the first virtual piece and an attribute of the first to-be-selected equipment, and the second recommendation priority being determined based on the attribute of the first virtual piece and an attribute of the second to-be-selected equipment.

For example, as shown in FIG. 10 (c), after a first selection operation is performed on a first virtual piece, a client displays a first equipment bar 66 in an equipment-switching state and a second equipment bar 67 in an equipment-switching state. If the first virtual piece is a virtual piece of an attack type (such as a shooter), equipment that improves damage performance thereof is preferentially recommended, and equipment whose attribute is a damage enhancement type is preferentially displayed in an equipment bar. Equipment having a relatively high matching degree with the attribute of the first virtual piece is preferentially recommended to a user, so that the attribute of the first virtual piece can be effectively improved, and the user can select the equipment quickly, thereby improving equipment providing efficiency.

In some embodiments, the attribute of the virtual piece includes at least one of the following: a character attack type, a character type, an attack type, a camp to which a character belongs, attack strength, a piece level/star level, a piece price, gender, an attack range, a hit point, and defensive power. For example, each virtual piece has a character attack type attribute and a character type attribute. The character attack type attribute includes a master, a warrior, an assassin, a shooter, an auxiliary, and the like. The character type attribute includes terrains, orcs, elves, protos, dwarves, and the like.

The first recommendation priority is configured for indicating a providing priority of first to-be-selected equipment, and the second recommendation priority is configured for indicating a providing priority of second to-be-selected equipment. In some embodiments, the first recommendation priority and the second recommendation priority are recommendation priorities of equipment that are determined through an AI model. Exemplarily, a priority model is trained based on first equipment providing data, and the priority model is configured to determine the first recommendation priority and the second recommendation priority. A parameter of the priority model is updated based on second equipment providing data. The first recommendation priority and the second recommendation priority are determined based on the priority model. The first equipment providing data is equipment providing data of all authorized user accounts, and the second equipment providing data is equipment providing data of a first account. The equipment providing data includes at least one of the following: a record that each equipment is provided for the first virtual piece, a record that each equipment is removed from the first virtual piece, a record that each equipment is migrated from another virtual piece to the first virtual piece, and a record that each equipment is migrated from the first virtual piece to another virtual piece.

In other words, the AI model is obtained through training based on the providing equipment data of all players. Then, the AI model is deployed to a current player, and a parameter of the AI model is updated based on the providing equipment data of the current player, so that the AI model matches the current player. In other words, a general basic model is generated based on the providing equipment data of all players, so as to substantially sort matching degrees between the virtual piece and the equipment. Then, the basic model is iterated based on a personal use habit of the current player, to generate a personalized model for the current player, so that the recommendation priority of equipment more conforms to a providing habit of the current player.

The user information and the providing equipment data involved in this embodiment of this application are information and data all authorized by the player or fully authorized by all parties, and collection, use, and processing of relevant data need to comply with relevant laws, regulations, and standards of relevant countries and regions.

The methods for displaying the equipment in three equipment bars shown in FIG. 10 may be used separately or may be used in a combination. For example, manners in FIG. 10 (b) and FIG. 10 (c) are combined to display virtual pieces currently provided with the equipment while the equipment is displayed in the second equipment bar. For another example, manners in FIG. 10 (a) and FIG. 10 (C) are combined. When at least two equipment in the second equipment bar (for example, the equipment bar 63 of the virtual piece C) exist, the equipment in the second equipment bar is sorted based on the recommendation priorities.

One of or both of the following operation 362 and operation 364 may be performed. If all operations are performed, the operations are not performed in a sequence. In other words, equipment provided with no any virtual piece may be provided for the first virtual piece. Alternatively, equipment on another virtual piece controlled by the first account is migrated to the first virtual piece.

Operation 362: Provide, in response to a second selection operation for selecting first to-be-selected equipment in the first equipment bar, the first to-be-selected equipment for the first virtual piece.

The first to-be-selected equipment is equipment belonging to the first account and provided with no any virtual piece.

The second selection operation is used as an operation of selecting equipment. The second selection operation may be implemented as at least one of a clicking/tapping operation, a double-clicking operation, a voice operation, a pressure touch operation, an eye control, and a somatosensory control, which is not limited in this embodiment of this application.

Exemplarily, when the second selection operation is the clicking/tapping operation, the client displays, in response to a second clicking/tapping operation for the first to-be-selected equipment in the first equipment bar, the first virtual piece provided with the first to-be-selected equipment. In other words, the client provides equipment that is provided with no any allied virtual piece for the first virtual piece.

Operation 364: Remove, in response to a second selection operation for selecting first equipment in a second equipment bar, the first equipment from the second virtual piece, and provide the first equipment for the first virtual piece.

The first equipment is equipment currently provided on the second virtual piece.

The second selection operation is used as an operation of selecting equipment. The second selection operation may be implemented as at least one of a clicking/tapping operation, a double-clicking operation, a voice operation, a pressure touch operation, an eye control, and a somatosensory control, which is not limited in this embodiment of this application.

Exemplarily, when the second selection operation is the clicking/tapping operation, a client undisplays, in response to a second clicking/tapping operation for the first equipment in the equipment bar, the first equipment on the second virtual piece, and displays the first virtual piece provided with the first equipment. In other words, the first equipment provided for the second virtual piece is migrated to the first virtual piece by the client.

For example, as shown in FIG. 5, after the first equipment (the equipment 35) in the equipment bar 33 is clicked/tapped, the first equipment is provided for the first virtual piece (the virtual piece A 31), the identifier icon 34 of the first equipment is displayed on an upper side of the first virtual piece, and the identifier icon 34 is removed on an upper side of the second virtual piece (the virtual piece B 32). In other words, migration of the first equipment from the second virtual piece to the first virtual piece is completed.

In some embodiments, after the migration of the first equipment from the second virtual piece to the first virtual piece is implemented, providing for the first virtual piece may be exit by clicking/tapping a blank area of the battle board or clicking/tapping the first virtual piece again. In other words, the client displays the first virtual piece in an unselected state in response to a third selection operation for selecting a blank area of the battle board after the first virtual piece is provided with the equipment. Alternatively, the client displays the first virtual piece in the unselected state in response to the first selection operation for selecting the first virtual piece again after the first virtual piece is provided with the equipment. The third selection operation may be implemented as at least one of a clicking/tapping operation, a double-clicking operation, a voice operation, a pressure touch operation, an eye control, and a somatosensory control.

For example, as shown in FIG. 7, the first virtual piece 41 on which providing is completed is displayed on the battle interface 40, the identifier icon 43 of the provided equipment is displayed on an upper side of the first virtual piece, and the piece position 46 where the first virtual piece 41 is located is displayed in bold by the client, to show that the first virtual piece 41 is in the selected state. In response to that the user clicks/taps the blank area 45 of the battle board (an area without a virtual piece on the battle board or outside the battle board) or clicks/taps the first virtual piece 41 again, the client displays the first virtual piece 41 in an unselected state. In other words, the client undisplays the piece position 46 in bold, so as to exit the equipment providing for the first virtual piece.

In some other embodiments, after the migration of the first equipment from the second virtual piece to the first virtual piece is implemented, an object for providing equipment may be switched by selecting the allied virtual piece other than the first virtual piece. In other words, in response to a first selection operation for selecting the third virtual piece, the third virtual piece in the selected state is displayed, and the first virtual piece in the unselected state is displayed after the first virtual piece is provided with the equipment, the third virtual piece being a virtual piece controlled by the first account other than the first virtual piece.

For example, as shown in FIG. 8, the first virtual piece 51 on which providing is completed is displayed on the battle interface 50, the identifier icon 53 of the provided equipment is displayed on an upper side of the first virtual piece, and the piece position 54 where the first virtual piece 51 is located is displayed in bold by the client, to show that the first virtual piece 51 is in the selected state. In response to that the user clicks/taps the third virtual piece 52, the client displays the first virtual piece 51 in an unselected state and displays the third virtual piece 52 in a selected state. In other words, the client undisplays the piece position 54 where the first virtual piece 51 is located in bold and displays a piece position 55 where the third virtual piece 52 is located in bold, so as to indicate switching from a providing state of the first virtual piece 51 to a providing state of the third virtual piece 52.

In some embodiments, a disassembler is required to remove the equipment from the virtual piece. The disassembler is configured to disassemble the equipment. Each disassembler may be simultaneously configured to disassemble one equipment, and each disassembler may also be simultaneously configured to disassemble one equipment of the virtual piece, which is not limited in this embodiment of this application. Exemplarily, when the first account has the disassembler, the client only displays the second equipment bar or displays the second equipment bar in the equipment-switching state. For example, as shown in FIG. 11, a first virtual piece 71 and a second virtual piece 72 are displayed on a battle interface 70, and the second virtual piece 72 is provided with equipment. The disassembler 73 is displayed in a first equipment bar. After the first virtual piece 71 is clicked/tapped, equipment 74 in a second equipment bar (in other words, equipment currently provided with the second virtual piece 72) is displayed. After the user clicks/taps the equipment 74 in the second equipment bar, the equipment 74 is migrated from the second virtual piece 72 to the first virtual piece 71, and one disassembler 73 is consumed simultaneously. If a user continues to click/tap equipment of another virtual piece in the second equipment bar, the client displays prompt information configured for indicating that a quantity of disassemblers is insufficient.

When equipment is provided for the first virtual piece, the disassembler needs to be consumed for detaching the equipment from the second virtual piece if the equipment is equipment migrated from the second virtual piece. One disassembler may migrate at least one equipment on one second virtual piece, and so on. Two disassemblers may migrate at least one equipment on two second virtual pieces, and so on. An existing disassembler is automatically deducted based on a quantity of the second virtual pieces after the providing for the first virtual piece is completed.

In some embodiments, when a quantity of the disassemblers is greater than or equal to the quantity of the second virtual pieces, the first equipment is removed from the second virtual piece in response to a second selection operation for selecting the first equipment in an equipment bar, and the first equipment is provided for the first virtual piece. Alternatively, when the quantity of the disassemblers is less than the quantity of the second virtual pieces, the prompt information indicating that the quantity of the disassemblers is insufficient is displayed, for example, prompt information “insufficient disassemblers, and equipment migration may not be performed” pops up.

Exemplarily, when the quantity of the disassemblers is greater than or equal to the quantity of the second virtual pieces, regardless of whether one second to-be-selected equipment needs to be migrated or a plurality of second to-be-selected equipment need to be migrated simultaneously, the second to-be-selected equipment may be directly migrated. When the quantity of the disassemblers is less than the quantity of the second virtual pieces, if the quantity of the second to-be-selected equipment to be simultaneously migrated is less than or equal to the quantity of the disassemblers, the second to-be-selected equipment may be directly migrated. If the quantity of the second to-be-selected equipment to be simultaneously migrated is greater than the quantity of the disassemblers, prompt information indicating that the quantity of the disassemblers is insufficient is displayed.

Alternatively, when the quantity of the disassemblers is greater than or equal to the quantity of the second virtual pieces, regardless of the quantity of the second virtual pieces on which equipment migration needs to be performed, the second to-be-selected equipment may be directly migrated. When the quantity of the disassemblers is less than the quantity of the second virtual pieces, if the quantity of the second virtual pieces on which equipment migration needs to be performed simultaneously is less than or equal to the quantity of the disassemblers, the second to-be-selected equipment may be directly migrated. If the quantity of the second virtual pieces on which equipment migration needs to be performed simultaneously is greater than the quantity of the disassemblers, prompt information indicating that the quantity of the disassemblers is insufficient is displayed, and equipment migration of the second virtual pieces (or equipment migration of the second virtual pieces) the same as the quantity of the disassemblers is performed, which is not limited in this embodiment of this application.

In this way, disassembling of the equipment is limited through the disassemblers, arousing a user to plan the equipment provision, to ensure reasonableness of disassembling of the equipment and reduce data changes and fluctuations related to equipment in a game battle, thereby reducing processing pressure of a computer device (such as a terminal device and a server).

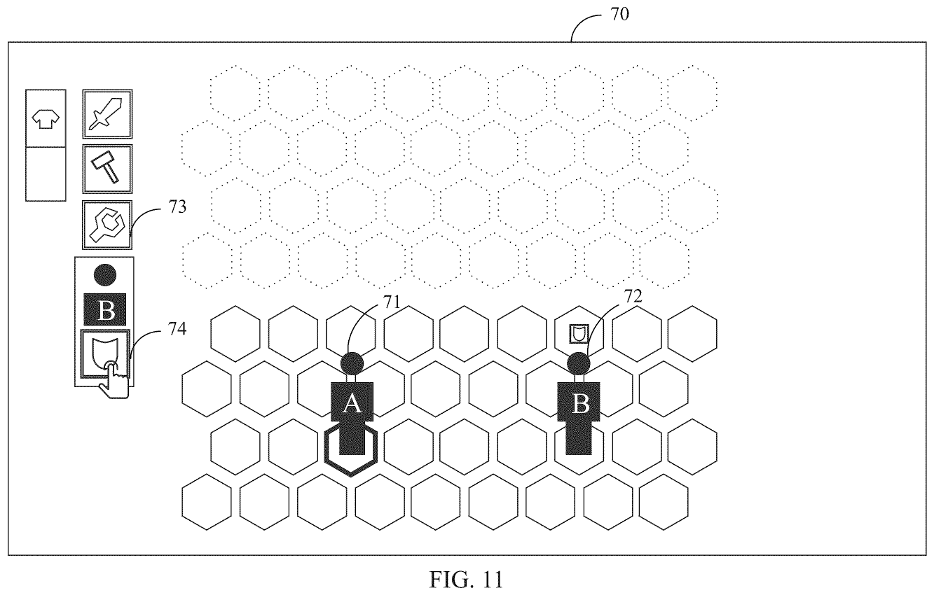

In some embodiments, after the first virtual piece is selected through the first selection operation, and equipment is selected through the second selection operation to provide the first virtual piece, a function entry may be set for the function. The function entry may be configured for selecting to enable or disable the function. The function entry may be set in a setting interface of the game, or a corresponding shortcut function entry may be set on a battle interface. For example, as shown in FIG. 12, a first virtual piece 81 and a second virtual piece 82, and a quick function entry 83 for providing the first virtual piece are displayed on a battle interface 80. A user may simply and quickly enable the function through the quick function entry, so as to implement fixed-point provision of the equipment for the first virtual piece. After the function is enabled, the disassembler is in an activated state (namely, may be used) if the disassembler exists.

Based on the above, according to the method provided in the embodiments of this application, after the first virtual piece is selected, the equipment provided on the second virtual piece in the equipment bar is selected, so that the equipment is provided for the first virtual piece, which implements fast switching of the equipment between the virtual pieces, avoids redundant operations of first disassembling the equipment and then re-assembling the equipment, and saves operation costs, thereby improving human-computer interaction efficiency. In addition, through fixed-point provision of the equipment (namely, the equipment does not need to be dragged), the accidental touches during equipment dragging are avoided, the providing time of the equipment is shortened, and the battle efficiency is improved.

In addition, the method provided in the embodiments of this application is also applicable to equipment that is provided with no any allied virtual pieces for the first virtual piece, so as to implement fixed-point provision of the equipment for the first virtual piece, and accidental touches does not occur during dragging the equipment from the equipment bar to the first virtual piece, thereby avoiding a problem of providing the equipment for an incorrect object, and improving providing accuracy and battle efficiency of the equipment.

In addition, according to the method provided in the embodiments of this application, the equipment bar is divided into the first equipment bar and the second equipment bar, so that an affiliation situation of the equipment is displayed more clearly, which helps the user select the equipment, thereby improving human-computer interaction efficiency.

In addition, according to the method provided in the embodiments of this application, the equipment in the second equipment bar and the virtual piece provided with the equipment are correspondingly displayed, so that the quantity of the disassemblers needing to be consumed is clearer, which helps the user select the equipment, thereby improving equipment providing efficiency and battle efficiency in a battle.

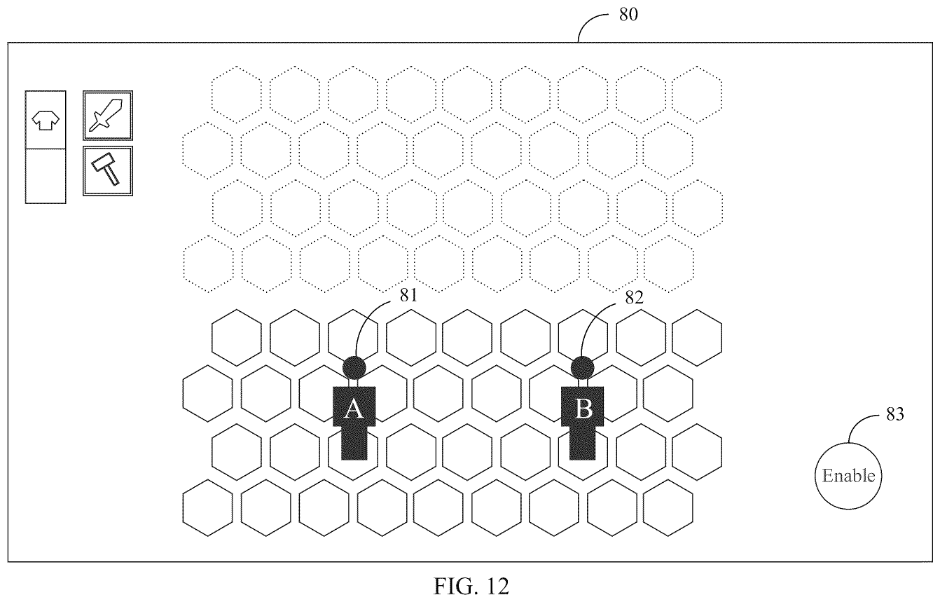

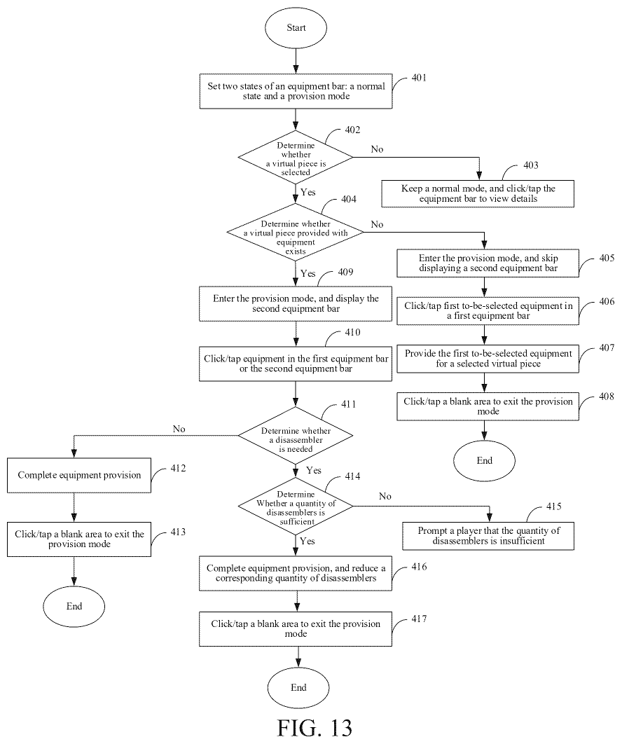

FIG. 13 is a flowchart of an equipment providing method for a virtual piece according to an exemplary embodiment of this application. The method may be performed by any terminal in FIG. 2 above or a client running on any terminal. The client is a client of a turn-based board game. The client is logged with a first account. The method includes the following operations.

Operation 401: Set two states of an equipment bar: a normal state and a provision mode.

Two different modes of the equipment bar are set, which respectively are a normal mode and a provision mode. The normal mode refers to a mode in which no allied virtual piece is selected, and the provision mode refers to a mode in which an allied virtual piece is selected for equipment providing.

In some embodiments, the equipment bar in the normal mode is displayed in a gloomy state, and the equipment bar in the provision mode is displayed in a highlighted state.

In some embodiments, after the equipment in the equipment bar in the normal mode is clicked/tapped, a client displays an information card of the equipment. The information card includes a name and description of the equipment for a user to check.

In some embodiments, the equipment bar in the normal mode only displays the first equipment bar in the foregoing embodiments. In other words, the equipment bar is configured to display the equipment provided with no any virtual piece. The equipment bar in the provision mode displays the first equipment bar and the second equipment bar in the foregoing embodiments, and the second equipment bar includes provided equipment.

Operation 402: Determine whether the virtual piece is selected.

It is determined whether a selected virtual piece exists in a current allied virtual piece. If the virtual piece in a selected state does not exist, operation 403 is performed. In other words, the equipment bar is kept in the normal mode. If the virtual piece in the selected state exists, an operation starting from operation 404 is performed. In other words, equipment providing is started.

Exemplarily, the client obtains an operation data invoking state (i.e., configured for indicating an operation of the user), and determines whether a player performs a selection operation on the virtual piece. When the player performs the selection operation on the virtual piece, the client displays the equipment bar in the provision mode. When the player does not perform the selection operation on the virtual piece, the client displays the equipment bar in the normal mode.

Operation 403: Keep a normal mode, and click/tap the equipment bar to view details.

When it is determined that the selected virtual piece does not exist in the current allied virtual pieces in operation 402, the equipment bar is kept in the normal mode. The player may click/tap the equipment in the equipment bar to view details of the equipment (for example, the client displays an information card including detailed descriptions of the equipment). In some embodiments, an initial mode of the equipment bar is the normal mode.

In some embodiments, the equipment bar in the normal mode is displayed in the gloomy state.

The equipment bar keeping in the normal mode in operation 403 refers to display only the first equipment bar in the foregoing embodiments. In other words, the equipment bar is configured to display the equipment provided with no any virtual piece.

Operation 404: Determine whether a virtual piece provided with equipment exists.

When it is determined that the selected virtual piece exists in the current allied virtual pieces in operation 402, it is determined whether the virtual piece provided with equipment exists.

Exemplarily, data of an allied virtual piece on a battle board is obtained, and it is determined whether the virtual piece provided with equipment exists. When the virtual piece provided with equipment exists, an operation starting from operation 409 is performed. In other words, a second equipment bar configured for displaying the equipment provided with the virtual piece is additionally displayed. When the virtual piece provided with equipment does not exist, operation 405 to operation 408 is performed. In other words, the second equipment bar is not displayed.

Operation 405: Enter the provision mode, and skip displaying the second equipment bar.

When it is determined that the virtual piece provided with equipment does not exist in operation 404, operation 405 is performed.

The client controls the equipment bar to enter the provision mode. In other words, a mode of performing equipment providing on the selected virtual piece is started. The second equipment bar is not displayed on the battle interface. In other words, only equipment in the first equipment bar can be selected to provide the selected virtual piece.

Operation 406: Click/tap first to-be-selected equipment in the first equipment bar.

The first to-be-selected equipment refers to equipment provided with no any allied virtual piece belonging to a first account.

Exemplarily, the player clicks/taps any of the first to-be-selected equipment in the first equipment bar.

Operation 407: Provide the first to-be-selected equipment for the selected virtual piece.

Exemplarily, after the player selects the first to-be-selected equipment, the client provides the first to-be-selected equipment for the selected virtual piece.

Operation 408: Click/tap a blank area to exit the provision mode.

The blank area includes an area without the virtual piece on the battle board or an area outside the battle board.

Exemplarily, the user may end equipment providing on the selected virtual piece by clicking/tapping the blank area, and the client displays the virtual piece in an unselected state.

In some embodiments, the user may also exit the provision mode of the virtual piece by clicking/tapping the selected virtual piece again, and the client displays the virtual piece in the unselected state. Alternatively, the user may also switch to the provision mode on another virtual piece by clicking/tapping another virtual piece, and the client displays the virtual piece in the unselected state and displays the newly selected virtual piece in the selected state.

Operation 409: Enter the provision mode, and display the second equipment bar.

When it is determined that the virtual piece provided with equipment exists in operation 404, operation 409 is performed.

The client controls the equipment bar to enter the provision mode. In other words, the equipment providing is started to perform on the selected virtual piece. The second equipment bar is additionally displayed on the battle interface. In other words, the player may select the equipment in the first equipment bar to provide the selected virtual piece, or may select the equipment in the second equipment bar to provide the selected virtual piece.

Exemplarily, the client obtains equipment data of the allied virtual piece provided with equipment, determines the equipment provided with the client, and displays the equipment in the second equipment bar.

In some embodiments, the equipment in the second equipment bar is displayed in groups based on the virtual piece on which the equipment is currently provided. In other words, the equipment in the second equipment bar is displayed correspondingly to the virtual piece provided with the equipment.

Operation 410: Click/tap the equipment in the first equipment bar or the second equipment bar.

Exemplarily, the player may select, by clicking the equipment in the first equipment bar or the second equipment bar, the equipment that needs to provide for the selected virtual piece. The client may determine, by detecting whether the clicking/tapping operation on the equipment exists, whether the equipment selected to be converted exists.

Operation 411: Determine whether a disassembler is needed.

The client determines whether the disassembler is needed. When the disassembler is not needed, operation 412 to operation 413 are performed; and when the disassembler is needed, an operation starting from operation 414 is performed.

In some embodiments, when the equipment is the equipment in the first equipment bar, the disassembler is not needed; and when the equipment is the equipment in the second equipment bar, the disassembler is needed.

Operation 412: Complete equipment provision.

When the equipment does not need the disassembler, the client completes providing on the selected virtual piece. The selected equipment in operation 410 is provided for the selected virtual piece.

Operation 413: Click/tap a blank area to exit the provision mode.

Exemplarily, the user may end equipment providing on the selected virtual piece by clicking/tapping the blank area, and the client displays the virtual piece in an unselected state.

In some embodiments, the user may also exit the provision mode of the virtual piece by clicking/tapping the selected virtual piece again, and the client displays the virtual piece in the unselected state. Alternatively, the user may further switch to the provision mode on another virtual piece by clicking/tapping another virtual piece, and the client displays the virtual piece in the unselected state and displays the newly selected virtual piece in the selected state.

Operation 414: Determine whether a quantity of disassemblers is sufficient.

When the disassembler is needed, it is determined whether the quantity of disassemblers is sufficient.

One disassembler may remove one or more equipment on one virtual piece. In other words, equipment on one virtual piece may be used as one group, and one disassembler may remove one group of equipment. By analogy, two disassemblers may remove two groups of equipment, and so on.

When a quantity of disassemblers is greater than or equal to a quantity of to-be-removed groups (i.e., a quantity of second virtual pieces in the foregoing embodiment). In other words, when the quantity of disassemblers is sufficient, operation 416 to operation 417 are performed. When a quantity of disassemblers is less than a quantity of to-be-removed groups, in other words, when the quantity of disassemblers is insufficient, operation 415 is performed.

Operation 415: Prompt the player that the quantity of disassemblers is insufficient.

When the quantity of disassemblers is insufficient, the player is prompted that the quantity of disassemblers is insufficient. For example, prompt information “insufficient disassemblers, and equipment migration may not be performed” pops up on the battle interface.

In some embodiments, the user may also perform equipment detachment for a corresponding quantity of groups based on the quantity of disassemblers.

Operation 416: Complete equipment provision, and reduce a corresponding quantity of disassemblers.

When the quantity of disassemblers is sufficient, the equipment providing on the selected virtual piece is completed. The selected equipment in operation 410 is provided for the selected virtual piece. In addition, the corresponding quantity of disassemblers in the equipment bar is reduced.

Operation 417: Click/tap a blank area to exit the provision mode.

Exemplarily, the user may end providing on the selected virtual piece by clicking/tapping the blank area, and the client displays the virtual piece in an unselected state.

In some embodiments, the user may also exit the provision mode of the virtual piece by clicking/tapping the selected virtual piece again, and the client displays the virtual piece in the unselected state. Alternatively, the user may further switch to the provision mode on another virtual piece by clicking/tapping another virtual piece, and the client displays the virtual piece in the unselected state and displays the newly selected virtual piece in the selected state.

Based on the above, according to the method provided in the embodiments of this application, in an equipment process of providing the virtual piece, equipment to be provided for the virtual pieces can be selected in the equipment bar only by selecting the virtual piece, thereby quickly providing the virtual piece, avoiding redundant operations of first disassembling and then dragging and providing the equipment, saving operation costs, and improving equipment providing efficiency of the virtual piece. In addition, when the virtual pieces on the battle board are dense, accidental touches easily caused by dragging the equipment to the virtual pieces may be effectively avoided, and the equipment of the virtual pieces may be accurately provided, thereby improving equipment providing accuracy of the virtual pieces.

Apparatus embodiments of this application are described below. For details not described in detail in the apparatus embodiments, reference may be made to the foregoing method embodiments.

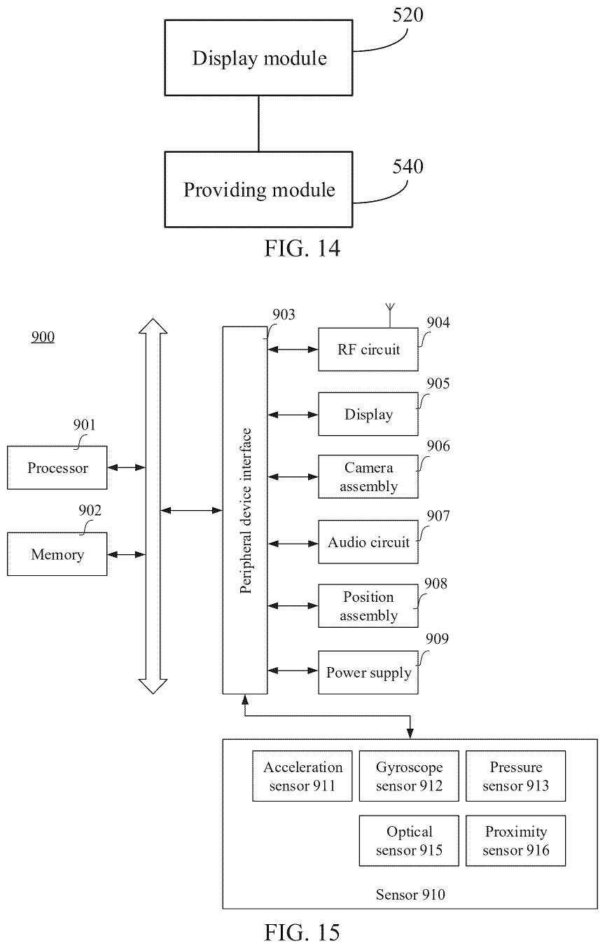

FIG. 14 is a block diagram of an equipment providing apparatus for a virtual piece according to an exemplary embodiment of this application. The apparatus includes a display module 520 and a providing module 540.

The display module 520 is configured to display a battle board of a turn-based board game, the battle board including a first virtual piece and a second virtual piece controlled by the first account, the second virtual piece being provided with first equipment.

The display module 520 is further configured to display the first virtual piece in a selected state in response to a first selection operation for selecting the first virtual piece. The providing module 540 is configured to remove, in response to a second selection operation for selecting the first equipment in an equipment bar, the first equipment from the second virtual piece, and equip the first virtual piece with the first equipment.

In an exemplary embodiment, the equipment bar includes a first equipment bar and a second equipment bar. The display module 520 is further configured to display the first equipment bar and the second equipment bar that are in an equipment-switching state in response to the first selection operation, the equipment-switching state being configured for indicating that an equipment is in a selectable state. The providing module 540 is configured to remove, in response to the second selection operation for selecting the first equipment in the second equipment bar, the first equipment from the second virtual piece, and provide the first equipment for the first virtual piece, the first equipment bar being configured for displaying first to-be-selected equipment belonging to the first account and provided with no any virtual piece, the second equipment bar being configured for displaying second to-be-selected equipment belonging to the first account and provided with a virtual piece other than the first virtual piece, and the second to-be-selected equipment including the first equipment.

In an exemplary embodiment, the second to-be-selected equipment in the second equipment bar is arranged in an order corresponding to the virtual piece provided with the second to-be-selected equipment.

In an exemplary embodiment, the display module 520 is further configured to display, in response to the first selection operation, the first equipment bar in the equipment-switching state, and the second equipment bar whose quantity is the same as a quantity of candidate equipment virtual pieces, a provided equipment of the candidate equipment virtual pieces corresponding to the second equipment bar being displayed in the second equipment bar, the candidate equipment virtual pieces being virtual pieces provided with at least one equipment other than the first virtual piece, and the candidate equipment virtual pieces including the second virtual piece.

In an exemplary embodiment, the first to-be-selected equipment in the first equipment bar is sorted based on a first recommendation priority, and the second to-be-selected equipment in the second equipment bar is sorted based on a second recommendation priority, the first recommendation priority being determined based on an attribute of the first virtual piece and an attribute of the first to-be-selected equipment, and the second recommendation priority being determined based on the attribute of the first virtual piece and an attribute of the second to-be-selected equipment.

In an exemplary embodiment, the display module 520 is further configured to display only the first equipment bar in the equipment-switching state in response to the first selection operation when no virtual piece provided with equipment exists.

In an exemplary embodiment, the providing module 540 is configured to provide, in response to a second selection operation for selecting the first to-be-selected equipment in the first equipment bar, the first to-be-selected equipment for the first virtual piece.

In an exemplary embodiment, the first selection operation and the second selection operation are clicking/tapping operations. The display module 520 is further configured to display the first virtual piece in the selected state in response to a first clicking/tapping operation for selecting the first virtual piece. The display module 520 is further configured to undisplay, in response to a second clicking/tapping operation for selecting the first equipment in the equipment bar, the first equipment on the second virtual piece, and display the first virtual piece provided with the first equipment.

In an exemplary embodiment, the display module 520 is further configured to: display the first virtual piece in an unselected state in response to a third selection operation for selecting a blank area of the battle board after the first virtual piece is provided with the equipment; or display the first virtual piece in the unselected state in response to the first selection operation for selecting the first virtual piece again after the first virtual piece is provided with the equipment.

In an exemplary embodiment, the display module 520 is further configured to display, in response to a first selection operation for selecting the third virtual piece, the third virtual piece in the selected state, and displaying the first virtual piece in the unselected state after the first virtual piece is provided with the equipment, the third virtual piece being a virtual piece controlled by the first account other than the first virtual piece.

In an exemplary embodiment remove, a disassembler is required to remove the equipment from the virtual piece. The providing module 540 is configured to: remove the first equipment from the second virtual piece in response to the second selection operation when a quantity of disassemblers is greater than or equal to a quantity of second virtual pieces, and provide the first equipment for the first virtual piece; or display prompt information indicating that the quantity of disassemblers is insufficient when the quantity of disassemblers is less than the quantity of second virtual pieces.

Based on the above, according to the method provided in the embodiments of this application, in an equipment process of providing the virtual piece, equipment to be provided for the virtual pieces can be selected in the equipment bar only by selecting the virtual piece, thereby quickly providing the virtual piece, avoiding redundant operations of first disassembling and then dragging and providing the equipment, saving operation costs, and improving equipment providing efficiency of the virtual piece. In addition, when the virtual pieces on the battle board are dense, accidental touches easily caused by dragging the equipment to the virtual pieces may be effectively avoided, and the equipment of the virtual pieces may be accurately provided, thereby improving equipment providing accuracy of the virtual pieces.

The equipment providing apparatus for a virtual piece provided in the foregoing embodiments, only division of the foregoing functional modules is used as an example for description. In practical application, the functions are completed by different functional modules as required. In other words, an internal structure of the device is divided into different functional modules to complete all or a part of the functions described above. In addition, the equipment providing apparatus for a virtual piece provided in the foregoing embodiment belongs to the same idea as the embodiment of the equipment providing method for a virtual piece. For a specific implementation thereof, reference is made to the method embodiment. Details are not described herein again.

This application further provides a terminal, including a processor and a memory, the memory having at least one instruction stored therein, the at least one instruction being loaded and executed by the processor to implement the equipment providing method for a virtual piece provided in the foregoing method embodiments. The terminal may be a terminal shown in FIG. 15.

FIG. 15 is a structural block diagram of a terminal 900 according to an exemplary embodiment of this application. The terminal 900 may be a smartphone, a tablet computer, an MP3 player, an MP4 player, a notebook computer, or a desktop computer. The terminal 900 may also be referred to as another name such as user equipment, a portable terminal, a laptop terminal, or a desktop terminal.

Generally, the terminal 900 includes a processor 901 and a memory 902.

The processor 901 may include one or more processing cores, for example, a 4-core processor or an 8-core processor. The processor 901 may be implemented in at least one hardware form of a digital signal processor (DSP), a field-programmable gate array (FPGA), and a programmable logic array (PLA). The processor 901 may alternatively include a main processor and a coprocessor. The main processor is configured to process data in an awake state, which is also referred to as a central processing unit (CPU). The coprocessor is a low-power processor configured to process data in a standby state. In some embodiments, the processor 901 may be integrated with a graphics processing unit (GPU). The GPU is configured to render and draw content that needs to be displayed on a display. In some embodiments, the processor 901 may further include an AI processor. The AI processor is configured to process computing operations related to machine learning.

The memory 902 may include one or more computer-readable storage media. The computer-readable storage medium may be non-transient. The memory 902 may further include a high-speed random access memory and a nonvolatile memory, for example, one or more disk storage devices or flash storage devices. In some embodiments, the non-transitory computer-readable storage medium in the memory 902 is configured to store at least one instruction. The at least one instruction is configured for being executed by the processor 901 to implement the equipment providing method for a virtual piece provided in the method embodiment of this application.

In some embodiments, the terminal 900 may alternatively include a peripheral device interface 903 and at least one peripheral device. The processor 901, the memory 902, and the peripheral device interface 903 may be connected through a bus or a signal cable. Each peripheral device may be connected to the peripheral device interface 903 through a bus, a signal line, or a circuit board. Specifically, the peripheral device includes at least one of a radio frequency (RF) circuit 904, a display 905, a camera assembly 906, an audio circuit 907, a position assembly 908, and a power supply 909.

The peripheral device interface 903 may be configured to connect the at least one peripheral device related to I/O to the processor 901 and the memory 902. In some embodiments, the processor 901, the memory 902, and the peripheral device interface 903 are integrated on the same chip or circuit board. In some other embodiments, any one or two of the processor 901, the memory 902, and the peripheral device interface 903 may be implemented on an independent chip or circuit board, which is not limited in this embodiment.

The RF circuit 904 is configured to receive and transmit an RF signal, which is also referred to as an electromagnetic signal. The RF circuit 904 communicates with a communication network and another communication device through the electromagnetic signal. The RF circuit 904 converts an electric signal into an electromagnetic signal for transmission, or converts a received electromagnetic signal into an electric signal. In some embodiments, the RF circuit 904 includes an antenna system, an RF transceiver, one or more amplifiers, a tuner, an oscillator, a DSP, a codec chipset, a user identity module card, and the like. The RF circuit 904 may communicate with the another terminal through at least one wireless communication protocol. The wireless communication protocol includes but is not limited to the World Wide Web, a metropolitan area network, the Intranet, various generations of mobile communication networks (2G, 3G, 4G, and 5G), a wireless local area network, and/or a wireless fidelity (Wi-Fi) network. In some embodiments, the RF circuit 904 may further include a near field communication (NFC)-related circuit, which is not limited in this application.

The display 905 is configured to display a UI. The UI may include a graph, text, an icon, a video, and any combination thereof. When the display 905 is a touch display, the display 905 further has a capability of collecting a touch signal on or above a surface of the display 905. The touch signal may be inputted to the processor 901 as a control signal for processing. In this case, the display 905 may be further configured to provide a virtual button and/or a virtual keyboard, which are/is also referred to as a soft button and/or a soft keyboard. In some embodiments, one display 905 may be arranged on a front panel of the terminal 900. In some other embodiments, at least two displays 905 may be respectively arranged on different surfaces of the terminal 900 or may be folded. In still other embodiments, the display 905 may be a flexible display arranged on a curved surface or a folding surface of the terminal 900. Even, the display 905 may be further set in a non-rectangular irregular pattern, namely, a special-shaped screen. The display 905 may be manufactured through a material such as a liquid crystal display (LCD) or an organic light-emitting diode (OLED).

The camera assembly 906 is configured to collect an image or a video. In some embodiments, the camera assembly 906 includes a front camera and a rear camera. Generally, the front camera is arranged on the front panel of the terminal, and the rear camera is arranged on the back of the terminal. In some embodiments, at least two rear cameras are arranged, which are respectively any of a main camera, a depth-of-field camera, a wide-angle camera, and a telephoto camera, to achieve background blurring through fusion of the main camera and the depth-of-field camera, panoramic photographing and virtual reality (VR) photographing through fusion of the main camera and the wide-angle camera, or another fusion photographing function. In some embodiments, the camera assembly 906 may further include a flash. The flashlight may be a single-color-temperature flashlight or a dual-color-temperature flashlight. The dual-color-temperature flashlight is a combination of a warm flashlight and a cold flashlight, which may be used for light compensation at different color temperatures.

The audio circuit 907 may include a microphone and a speaker. The microphone is configured to collect a sound wave of a user and an environment, and convert the sound wave into an electrical signal and input the electrical signal to the processor 901 for processing, or input the electrical signal to the RF circuit 904 to achieve voice communication. For the purpose of stereo acquisition or noise reduction, a plurality of microphones may be respectively arranged at different parts of the terminal 900. The microphone may alternatively be an array microphone or an omnidirectional collection microphone. The speaker is configured to convert an electrical signal from the processor 901 or the RF circuit 904 into a sound wave. The speaker may be a conventional film speaker, or may be a piezoelectric ceramic speaker. When the speaker is the piezoelectric ceramic speaker, the speaker can not only convert an electric signal into a sound wave audible to human beings, but also convert the electric signal into a sound wave inaudible to human beings for ranging and the like. In some embodiments, the audio circuit 907 may further include an earphone jack.

The position assembly 908 is configured to determine a current geographical position of the terminal 900, to implement navigation or a location based service (LBS). The position assembly 908 may be a position assembly based on the global positioning system (GPS), the BeiDou system, or the Galileo system.

The power supply 909 is configured to supply power to assemblies in the terminal 900. The power supply 909 may be an alternating current power supply, a direct current power supply, a disposable battery, or a rechargeable battery. When the power supply 909 includes the rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal 900 further includes one or more sensors 910. The one or more sensors 910 include but are not limited to an acceleration sensor 911, a gyroscope sensor 912, a pressure sensor 913, an optical sensor 915, and a proximity sensor 916.

The acceleration sensor 911 may detect a magnitude of acceleration on three coordinate axes of a coordinate system established by using the terminal 900. For example, the acceleration sensor 911 may be configured to detect components of gravity acceleration on the three coordinate axes. The processor 901 may control, according to a gravity acceleration signal collected by the acceleration sensor 911, the display 905 to display the UI in a landscape view or a portrait view. The acceleration sensor 911 may be further configured to collect movement data of a game or a user.

The gyroscope sensor 912 may detect a body direction and a rotation angle of the terminal 900. The gyroscope sensor 912 may cooperate with the acceleration sensor 911 to acquire a 3D action by the user on the terminal 900. The processor 901 may implement the following functions according to the data collected by the gyro sensor 912: movement sensing (for example, changing the UI based on a tilt operation of the user), image stabilization during shooting, game control, and inertial navigation.

The pressure sensor 913 may be arranged at a side frame of the terminal 900 and/or a lower layer of the display 905. When the pressure sensor 913 is arranged at the side frame of the terminal 900, a holding signal of the user on the terminal 900 may be detected. The processor 901 performs left/right hand recognition or a quick operation based on the holding signal acquired by the pressure sensor 913. When the pressure sensor 913 is arranged on the lower layer of the display 905, the processor 901 controls, based on a pressure operation of the user on the display 905, an operable control on the UI. The operable control includes at least one of a button control, a scroll-bar control, an icon control, and a menu control.

The optical sensor 915 is configured to collect ambient light intensity. In an embodiment, the processor 901 may control display brightness of the display 905 based on the ambient light intensity collected by the optical sensor 915. Specifically, when the ambient light intensity is relatively high, the display brightness of the display 905 is increased. When the ambient light intensity is relatively low, the display brightness of the display 905 is reduced. In another embodiment, the processor 901 may further dynamically adjust a camera parameter of the camera assembly 906 based on the ambient light intensity collected by the optical sensor 915.

The proximity sensor 916, also referred to as a distance sensor, is generally arranged on the front panel of the terminal 900. The proximity sensor 916 is configured to collect a distance between the user and the front of the terminal 900. In an embodiment, when the proximity sensor 916 detects that the distance between the user and the front side of the terminal 900 gradually decreases, the processor 901 controls the display 905 to be switched from a screen-on state to a screen-off state. When the proximity sensor 916 detects that the distance between the user and the front of the terminal 900 gradually increases, the processor 901 controls the display 905 to be switched from the screen-off state to the screen-on state.

A person skilled in the art may understand that, the structure shown in FIG. 15 constitutes no limitation on the terminal 900, and the terminal may include more or fewer assemblies than those shown in the figure, or some assemblies may be combined, or a different assembly arrangement may be used.

The memory further includes one or more programs. The one or more programs are stored in the memory. The one or more programs include a program for performing the equipment providing method for a virtual piece provided in the embodiments of this application.

This application provides a non-transitory computer-readable storage medium, the storage medium having at least one instruction stored therein, the at least one instruction being loaded and executed by a processor to implement the equipment providing method for a virtual piece provided in the foregoing method embodiments.

This application further provides a computer program product, including a computer instruction, the computer instruction being stored in a non-transitory computer-readable storage medium. A processor of a computer device reads the computer instruction from the computer-readable storage medium, and the processor executes the computer instruction, to cause the computer device to perform the equipment providing method for a virtual piece provided in the foregoing implementations.

The serial numbers of the foregoing embodiments of this application are merely for description, and do not represent the preference of the embodiments.

A person of ordinary skill in the art may understand that all or some of the operations of the foregoing embodiments may be implemented by hardware, or may be implemented by a program instructing relevant hardware. The program may be stored in a non-transitory computer-readable storage medium. The storage medium may be a read-only memory, a magnetic disk, an optical disc, or the like.

The above descriptions are merely exemplary embodiments of this application, and are not intended to limit this application. Any modification, equivalent replacement, or improvement made within the spirit and principle of this application falls within the protection scope of this application.

In this application, a prompt interface or a pop-up window can be displayed, or voice prompt information can be outputted before acquiring user-related data and when acquiring user-related data. The prompt interface, the pop-up window, or the voice prompt information is configured for prompting the user that user-related data is currently being acquired. In this way, in this application, related operations of obtaining the user-related data only start to be executed after obtaining a confirmation operation of the user on the prompt interface or the pop-up window. Otherwise (i.e., when the confirm operation performed by the user on the prompt interface or the pop-up window is not obtained), the related operations of obtaining the user-related data are ended. In other words, the user-related data is not obtained. In other words, all user data collected in this application is processed in strict accordance with a requirement of relevant national laws and regulations, and an informed consent or an individual consent of a personal information subject is collected with consent and authorization of the user. Within the scope of laws and regulations and the authorization of the personal information subject, the subsequent use and processing of data and the collection, use and processing of relevant user data shall comply with the relevant laws, regulations, and standards of relevant countries and regions. For example, the battle interface, the selection operation, the account, and the like involved in this application are obtained under full authorization.

What is claimed is:

1. A method for moving equipment between virtual pieces in an online board game performed by a computer device, the method comprising:
displaying a battle board, the battle board including a first virtual piece and a second virtual piece controlled by a first account of the online board game;
in response to a first selection operation on the first virtual piece, updating the first virtual piece to be in a selected state and displaying first equipment associated with the second virtual piece in an equipment bar on the battle board; and
in response to a second selection operation on the first equipment in the equipment bar, dynamically moving the first equipment from the second virtual piece to the first virtual piece in the battle board.

2. The method according to claim 1, wherein the equipment bar comprises a first equipment bar and a second equipment bar including the first equipment associated with the second virtual piece, and the method further comprises:
causing the first equipment bar and the second equipment bar to be in an equipment-switching state in response to the first selection operation on the first virtual piece; and
moving the first equipment from the second virtual piece to the first virtual piece in response to the second selection operation on the first equipment in the second equipment bar,
the first equipment bar including to-be-selected equipment belonging to the first account, the second equipment bar including equipment belonging to the first account and having been selected by a virtual piece other than the first virtual piece.

3. The method according to claim 2, wherein the having-been-selected equipment in the second equipment bar is arranged in an order corresponding to an order of the virtual pieces provided with the having-been-selected equipment.

4. The method according to claim 2, further comprising:
displaying only the first equipment bar in the equipment-switching state in response to the first selection operation when no virtual piece provided with equipment exists.

5. The method according to claim 2, further comprising:
in response to a second selection operation on the to-be-selected equipment in the first equipment bar, assigning the to-be-selected equipment to the first virtual piece.

6. The method according to claim 1, further comprising:
updating the first virtual piece to be in an unselected state in response to a third selection operation on a blank area of the battle board or the first virtual piece again after the first virtual piece is provided with the equipment.

7. The method according to claim 1, further comprising:
in response to a first selection operation on a third virtual piece, causing the third virtual piece to be in the selected state, and displaying the first virtual piece in the unselected state after the first virtual piece is provided with the equipment, the third virtual piece being a virtual piece controlled by the first account other than the first virtual piece.

8. The method according to claim 1, wherein the dynamically moving the first equipment from the second virtual piece to the first virtual piece in the battle board includes:
moving the first equipment from the second virtual piece to the first virtual piece in response to the second selection operation when a quantity of disassemblers is greater than or equal to a quantity of second virtual pieces; and
displaying prompt information indicating that the quantity of disassemblers is insufficient when the quantity of disassemblers is less than the quantity of second virtual pieces.

9. A computer device, comprising a processor and a memory, the memory having at least one program stored therein, the at least one program, when being loaded and executed by the processor, causing the computer device to implement a method for moving equipment between virtual pieces in an online board game, the method comprising:
displaying a battle board, the battle board including a first virtual piece and a second virtual piece controlled by a first account of the online board game;
in response to a first selection operation on the first virtual piece, updating the first virtual piece to be in a selected state and displaying first equipment associated with the second virtual piece in an equipment bar on the battle board; and
in response to a second selection operation on the first equipment in the equipment bar, dynamically moving the first equipment from the second virtual piece to the first virtual piece in the battle board.

10. The computer device according to claim 9, wherein the equipment bar comprises a first equipment bar and a second equipment bar including the first equipment associated with the second virtual piece, and the method further comprises:
causing the first equipment bar and the second equipment bar to be in an equipment-switching state in response to the first selection operation on the first virtual piece; and
moving the first equipment from the second virtual piece to the first virtual piece in response to the second selection operation on the first equipment in the second equipment bar,
the first equipment bar including to-be-selected equipment belonging to the first account, the second equipment bar including equipment belonging to the first account and having been selected by a virtual piece other than the first virtual piece.

11. The computer device according to claim 10, wherein the having-been-selected equipment in the second equipment bar is arranged in an order corresponding to an order of the virtual pieces provided with the having-been-selected equipment.

12. The computer device according to claim 10, wherein the method further comprises:
displaying only the first equipment bar in the equipment-switching state in response to the first selection operation when no virtual piece provided with equipment exists.

13. The computer device according to claim 10, wherein the method further comprises:
in response to a second selection operation on the to-be-selected equipment in the first equipment bar, assigning the to-be-selected equipment to the first virtual piece.

14. The computer device according to claim 9, wherein the method further comprises:
updating the first virtual piece to be in an unselected state in response to a third selection operation on a blank area of the battle board or the first virtual piece again after the first virtual piece is provided with the equipment.

15. The computer device according to claim 9, wherein the method further comprises:
in response to a first selection operation on a third virtual piece, causing the third virtual piece to be in the selected state, and displaying the first virtual piece in the unselected state after the first virtual piece is provided with the equipment, the third virtual piece being a virtual piece controlled by the first account other than the first virtual piece.

16. The computer device according to claim 9, wherein the dynamically moving the first equipment from the second virtual piece to the first virtual piece in the battle board includes:
moving the first equipment from the second virtual piece to the first virtual piece in response to the second selection operation when a quantity of disassemblers is greater than or equal to a quantity of second virtual pieces; and
displaying prompt information indicating that the quantity of disassemblers is insufficient when the quantity of disassemblers is less than the quantity of second virtual pieces.

17. A non-transitory computer-readable storage medium, having at least one program stored therein, the at least one program, when being loaded and executed by a processor of a computer device, causing the computer device to implement a method for moving equipment between virtual pieces in an online board game, the method comprising:
displaying a battle board, the battle board including a first virtual piece and a second virtual piece controlled by a first account of the online board game;
in response to a first selection operation on the first virtual piece, updating the first virtual piece to be in a selected state and displaying first equipment associated with the second virtual piece in an equipment bar on the battle board; and
in response to a second selection operation on the first equipment in the equipment bar, dynamically moving the first equipment from the second virtual piece to the first virtual piece in the battle board.

18. The non-transitory computer-readable storage medium according to claim 17, wherein the equipment bar comprises a first equipment bar and a second equipment bar including the first equipment associated with the second virtual piece, and the method further comprises:
causing the first equipment bar and the second equipment bar to be in an equipment-switching state in response to the first selection operation on the first virtual piece; and
moving the first equipment from the second virtual piece to the first virtual piece in response to the second selection operation on the first equipment in the second equipment bar,
the first equipment bar including to-be-selected equipment belonging to the first account, the second equipment bar including equipment belonging to the first account and having been selected by a virtual piece other than the first virtual piece.

19. The non-transitory computer-readable storage medium according to claim 17, wherein the method further comprises:
updating the first virtual piece to be in an unselected state in response to a third selection operation on a blank area of the battle board or the first virtual piece again after the first virtual piece is provided with the equipment.

20. The non-transitory computer-readable storage medium according to claim 17, wherein the method further comprises:
in response to a first selection operation on a third virtual piece, causing the third virtual piece to be in the selected state, and displaying the first virtual piece in the unselected state after the first virtual piece is provided with the equipment, the third virtual piece being a virtual piece controlled by the first account other than the first virtual piece.
